(19) United States
(12) Patent Application Publication
(10) Pub. No.: US 2011/0246212 A1
(43) Pub. Date: Oct. 6, 2011

(54) METHOD AND SYSTEM FOR HIGH VALUE ASSET REGISTRATION, AUTHENTICATION, CLEAR TITLE UNDERWRITING, VALUATION, WORKFLOW MANAGEMENT, TRADING AND LIEN RECORDING

(76) Inventor: Scott A. Barnes, Dallas, TX (US)

(21) Appl. No.: 13/079,749

(22) Filed: Apr. 4, 2011

Related U.S. Application Data
(60) Provisional application No. 61/320,519, filed on Apr. 2, 2010.

(51) Int. Cl. G06Q 99/00

(52) U.S. Cl. 705/1.1

(57) ABSTRACT

A method and system for high value asset registration, authentication, clear title underwriting, valuation, work flow management, trading and lien recording are described. According to one embodiment, a computer-implement method comprises receiving from one or more client computers, a high value asset registration request. High value asset data is received. The high value asset data includes one or more of high value asset description data, high value asset image data, clear title underwriting data, trading platform data, lien data, work flow management data, artist and designer data, assessment protocol and valuation data, insurance provider data, administrative data, business development data, historical sales transaction data, auction and private sales data, and dealer demand data.

### CROSS REFERENCE TO RELATED APPLICATIONS

The present application claims the benefit of and priority to U.S. provisional patent application Ser. No. 61/320,519, entitled “A Method and System for High Value Asset Registration, Authentication, Valuation, Trading and Lien Recording” filed on Apr. 2, 2010, and is hereby incorporated by reference.

### FIELD

The present invention relates to a method and system of registration, lien recording, insurance recording, authentication, clear title underwriting, valuation, work flow management, trading and sale of high value assets.

### BACKGROUND

The global fine art market is completely unregulated. It is a lucrative industry that is flush with cash, and according to a survey by the European Fine Arts Foundation reported in ARTnews magazine, it has grown by 95% between 2002 and 2006 from $25.3 billion to $54.9 billion. Annual private art sales alone total 25 to 30 billion dollars, according to the magazine, and despite global economic insecurity, auction houses continue to set records. On May 14, 2008, a 1976 triptych by Francis Bacon sold for $86.3 million and became the most expensive work of postwar art ever sold at auction. On May 4, 2010, Pablo Picasso's Nu au Plateau de Sculpteur sold at auction for $106.5 million, becoming the most expensive painting sold at auction.

Similarly, it is estimated that art crime and art fraud is the third largest-grossing crime in the world behind illegal drugs and illegal arms trafficking; illegal drug trafficking in the United States alone brings in up to $64 billion a year. However, the scale of the problem of fine art fraud is international; therefore, the impact is utterly staggering.

In addition to art crime and art fraud, another problem in the global fine art market is associated with art title. The art title problem has existed for some time and was first illustrated in the context of claims of fine art seized during World War II. In 2007 a highly publicized title dispute involving director Steven Spielberg became a cautionary tale for collectors. In 1989 Spielberg purchased a Norman Rockwell painting, Russian Schoolroom, that, unbeknownst to him, had been stolen from a Missouri gallery 16 years earlier. At the end of the dispute, Spielberg without art title insurance, was not only out the $700,000 value of the painting but also his legal fees. As these types of title disputes present themselves, the fine art market becomes more aware and risk-averse.

The issues of art crime, art fraud and art title, combined with the increasing complexity of art transactions that involve investment funds; the tendency to lend against art; the inclination for people to regard art as a distinct asset class; and the increasing value of art, present a need for a system to provide risk management for the financial risk associated with the global art marketplace. There is a need for a trading system that maintains the integrity of art history and its unique industry customs, detects art forgery and title defects, establishes common assessment standards and upholds the social and financial value of fine art, thus preserving the quality of aesthetics and human value in fine art.

### SUMMARY

A method and system for high value asset registration, authentication, clear title underwriting, valuation, work flow management, trading and lien recording are described. According to one embodiment, a computer-implement method comprises receiving from one or more client computers, a high value asset registration request. High value asset data is received. The high value asset data includes one or more of high value asset description data, high value asset image data, clear title underwriting data, trading platform data, lien data, work flow management data, artist and designer data, assessment protocol and valuation data, insurance provider data, administrative data, business development data, historical sales transaction data, auction and private sales data, and dealer demand data.

### BRIEF DESCRIPTION OF THE DRAWINGS

FIG. 1 illustrates the assigned user roles that access and use the high value asset server, according to one embodiment.

FIG. 2 illustrates the modules which function within the high value asset server, according to one embodiment.

FIG. 3 illustrates flow charts of the functions of the title registration module including the title registration process (A), the viewing process for the owner of the high value asset (B), and the viewing process of the other parties of interest (C), according to one embodiment.

FIG. 4A illustrates a flow chart of the insurance provider module, according to one embodiment.

FIG. 4B illustrates a flow chart of the insurance underwriting module, according to one embodiment.

FIG. 5 illustrates a flow chart of the lien holder module, according to one embodiment.

FIG. 6 illustrates flow charts for the parts dealer registration process, including the dealer registration request submission (A), dealer registration request review (B), due diligence form completion (C) and due diligence form review (D), according to one embodiment.

FIG. 7 illustrates a flow chart of an assessment and valuation process involving a research specialist (A), expert committee members and the research director (B), according to one embodiment.

FIG. 8 illustrates a flow chart of a trading platform module for the offering of a high value asset (A) and the optioning of the high value asset (B), according to one embodiment.

FIG. 9 illustrates a flow chart of a marketing module where the business developer assists with the offering process of a high value asset (A), the option process of the high value asset (B) and the demand process (C), according to one embodiment.

FIG. 10 illustrates a flow chart of a transaction audit module, according to one embodiment.

FIG. 11 illustrates a flow chart of an administrative module, according to one embodiment.

FIG. 12 illustrates a flow chart of a viewing module for uploading pictures (A) and viewing in 3-D (B) and high resolution 2-D (C), according to one embodiment.

### DETAILED DESCRIPTION

The present method and system pertain to high value asset registration, authentication, clear title underwriting, valuation, work flow management, trading and lien recording. For example, an individual collector or international art dealer may register an ownership interest in an original work by Pablo Picasso using the present system to document ownership for insurance, financial lending or trading purposes and to permanently record the work's provenance, historical and factual documentation, condition, and to report and/or record insurance coverage and any liens against the title of ownership. The system aids the process of authentication, provenance documentation and valuation, establishing a chain of title for the asset and the recording of liens against the title ownership and recording if a work is stolen. Additional features of the system are described herein.

As used herein, the term “appraisal” or “valuation” refers to the estimate of the monetary value and determines the worth of a high value asset. The appraisal process includes the evaluation of the item/artist description, provenance, clear title and auction and private transaction records for the artist, general assessment of authenticity and the quality and condition of the high value asset to determine the price for the high value asset. The appraisals are prepared in accordance with the guidelines and standards of the American Society of Appraisers as well as the guidelines of the American Appraisers Association, the American Society of Certified Appraisers and all major appraisers associations, with the codes and ethics of these associations strictly applied. The price provided by the appraisal process for the high value asset includes a fair market value or replacement value of the asset for trading, gifting and insurance purposes.

The term “authenticate” as used herein refers to the verification of the high value asset as genuine by establishing the attribution of the high value asset on the basis of the judgment of any expert skilled in the attribution of works of art. In formulating this judgment, the expert will take into consideration the results of connoisseurship, prior scholarship, provenance research and scientific analysis. Connoisseurship is the comparative analysis and study of the high value asset in terms of a match between the style of the high value asset, the technique in which it is executed and the choice of subject matter and other works that prior scholarship has generally agreed are to be attributed to an identifiable artist at a given point in time. The investigation of the provenance is a search for supporting documents to establish the chain of title of the high value asset from the hand of the artist, if possible, and subsequent transactions supporting the passing of the chain of title. This may include finding and looking at prior sale slips and invoices, auction records, probate, estate and bequeaths, estate property lists, taxes paid on properties sold, catalogues raisonnés, expert publications and international databases of and research services indicating a work's ownership.

The scientific analysis and investigation of the high value asset can include the analysis of the materials of the high value asset, such as the paint, canvas, wood, or type of stone or metal used in the high value asset, to determine that these material bases are appropriate in terms of date produced and materials used. In order to establish the credibility and authenticity of the high value asset, some scientific techniques used in the analysis may include spectral and optical analysis (ultraviolet, infrared, X-ray diagnostics, spontaneous Raman spectroscopy), chemical analysis of pigments, radio carbon dating, dendrochronology and forensic handwriting analysis. Art authentication is a critical measure in maintaining the integrity of the art market and in the detection and prosecution of art forgery. It upholds the social and financial value of the high value asset. The authentication process determines that the work is indeed by the artist as stated. Not only does the present system identify outright forgeries; it also determines that the work is substantially by the hand of the artist and is not by a studio apprentice, or by a follower, or merely in the style of, or school of the artist. The precise meanings of these different levels of attribution are generally understood, standardized and widely used within the art trade.

As used herein, the term “client computer” refers to any computer used to connect to the high value asset server, such as those used by the numerous user roles described in more detail below.

The term “demand,” as used herein, signifies the current ability or the current willingness of an international dealer, collector or other interested or prospective buying party to buy a particular high value asset at a given point of time at a single or range of prices as denoted by a dealer.

As used herein, the term “fair market value” or “FMV” is defined as the price at which the property would change hands between a willing buyer and a willing seller with neither being under any compulsion to buy or to sell. The fair market value of a particular item of property is not to be determined by a forced sale price, nor is the fair market value of an item of property to be determined by the sale price of the item in a market other than that in which such item is most commonly sold, taking into account the location of the item wherever appropriate. A fair market value calculation is dependent on numerous considerations, which include artist, subject matter, prior comparable sales transactions (auction sales, private sales and prior systems sales), condition, provenance and demand factors. The estimate of FMV is documented in a high value asset server. The documentation of FMV includes the basis of the valuation, such as the comparable transactions (auction, private sales and high value asset server system sales) included in the analysis and the existence of a demand from known sources for the work.

The term “high value asset,” as used herein, refers to the visual fine art in a fixed or multi-medium, including but not limited to, paintings, sculptures, collages, assemblages, mosaics, installations, calligraphy, prints, illustrations, drawings, film stills, photographs, computer generated images, jewelry and the like. High value assets can also be referred to as a “work” or “works.”

As used herein, the term “offer” refers to the firm proposal of intent to give or pay a cash price for a high value asset.

The term “major market,” as used herein, refers to the generally recognized primary periods and markets customarily recognized by those parties that transact in the fine art market, such as the Old Masters, Impressionist/Modern, Contemporary, 18^{th-}20^{th} Century European, 18^{th}-20^{th} Century American and similar market categories.

As used herein, the term “minor market” refers to a submarket of a Major Market that is denoted by artist nationality such as French Impressionist, Dutch Old Master or British Modern, as well as sub descriptions of works as landscapes, still life, abstraction and schools of art such as Ash Can School, Fauvism, Orientalism, Hudson River School and New York School.

As used herein, the term “option” is an agreement to keep open or independently obtain the right to offer to sell or purchase a high value asset for a set period of time. Types of options include, but are not limited to, 7-day exclusivity options, 3-month exclusivity option price, exhibition option price (per exhibition venue) and publication option price (varying lengths of time).

The term “replacement value,” as used herein, is defined as the amount it would cost to replace an item with one of similar and like quality purchased in the most appropriate marketplace within a limited amount of time.

As used herein, the “report period” for the report module can be by day, week, month, quarter or year, or the internal user can customize the period by indicating the “to” date and “from” date.

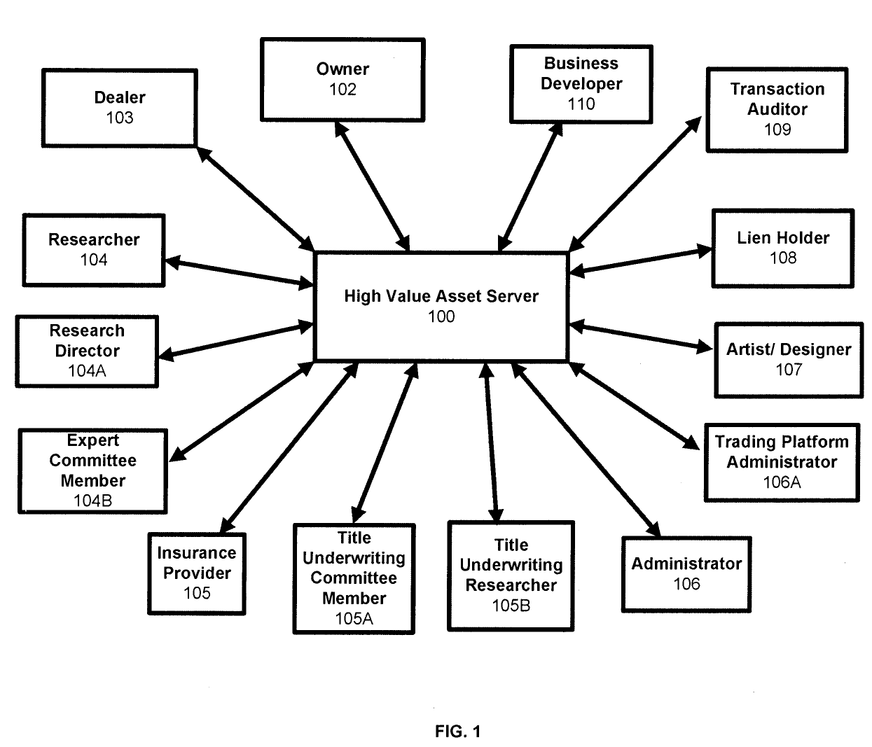

FIG. 1 illustrates the roles that access and use the high value asset server 100. The roles that can access the high value asset server 100 are both users that are internal to the high value asset server 100 as well as users that are external to the high value asset server 100. Internal users include a research specialist 104, research director 104A, expert committee member 104B, an administrator 106, trading platform administrator 106A, title underwriting committee member 105A, title underwriting researcher 105B, a transaction auditor 109 and a business developer 110. External users include high value asset owners 102, dealers 103, insurance providers 105, artist/designers 107 and lien holders 108. Each role has a unique interface which is associated with its user ID and password. Thus, the interface for the respective user role comprises different types of information due to the variation in the functions, permissions, internal controls and firewalls for the respective user role, which will be discussed with the modules associated with the user roles below. Each role has a unique “Today Page” to interface with the system.

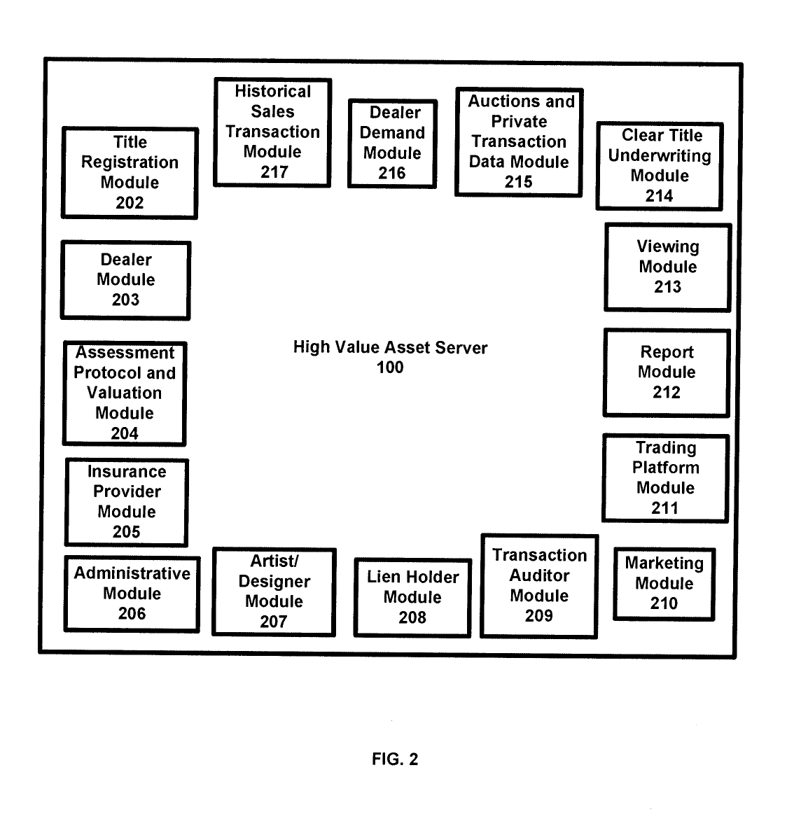

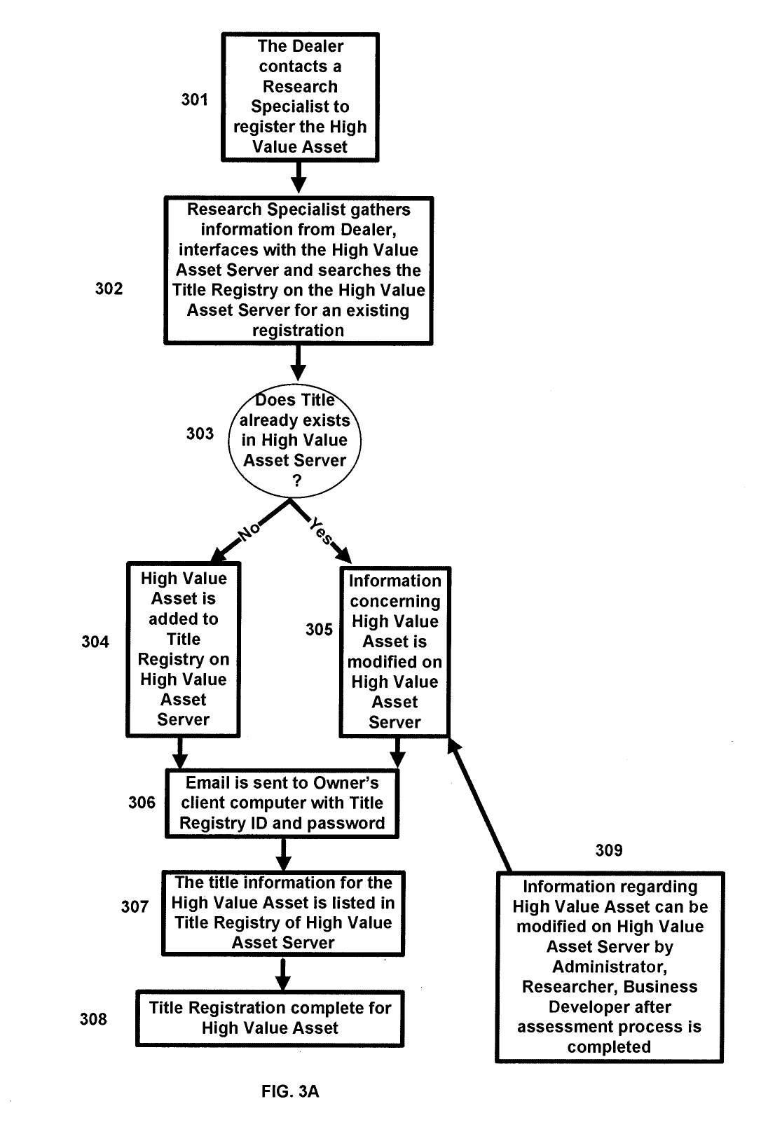

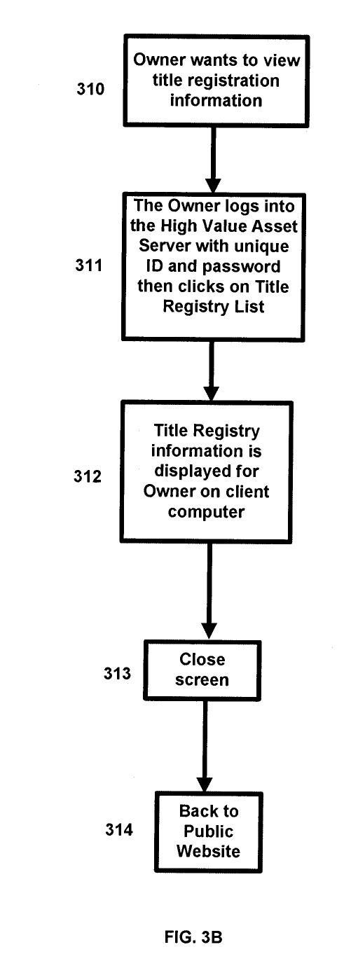

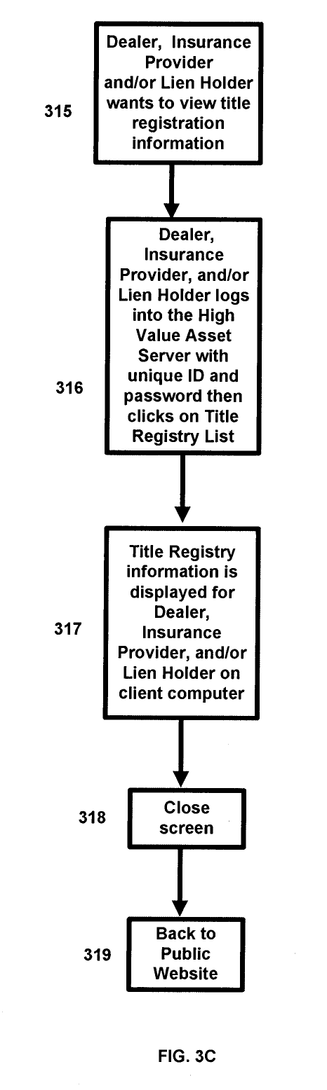

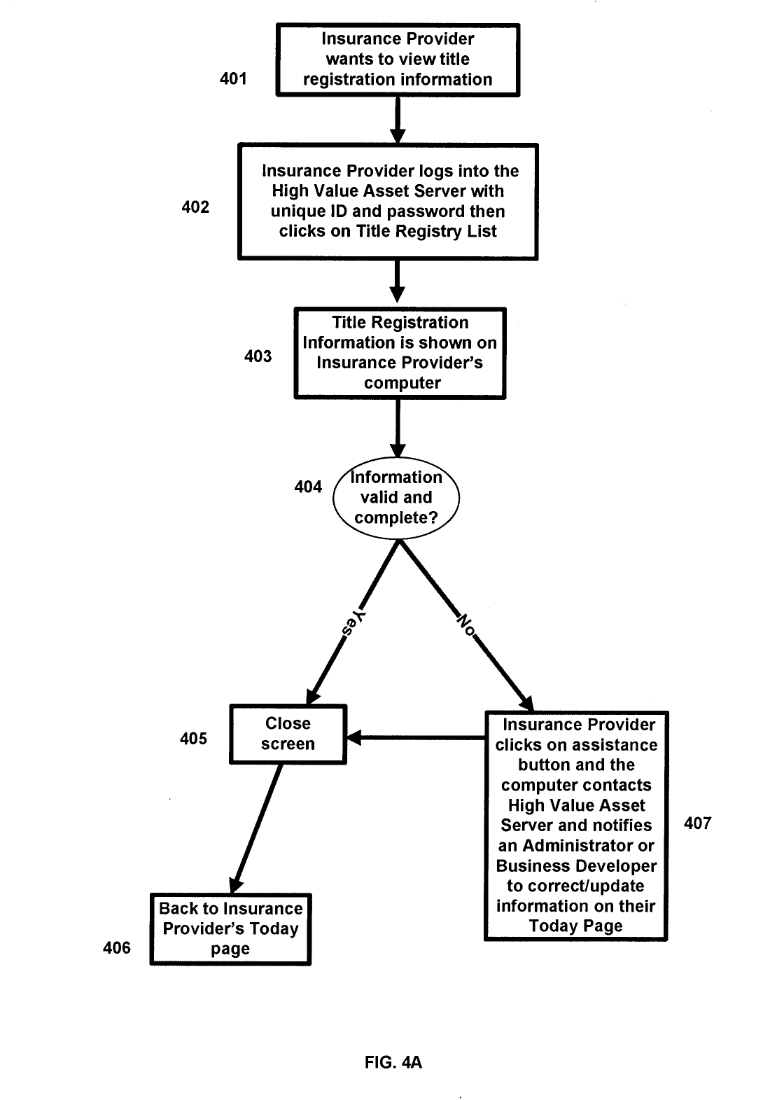

FIG. 2 illustrates the modules that function within the high value asset server 100. These modules include title registration module 202, dealer module 203, assessment protocol and valuation module 204, insurance provider module 205, administrative module 206, artist/designer module 207, lien holder module 208, transaction module 209, marketing module 210, trading platform module 211, report module 212, viewing module 213, clear title underwriting module 214, auction sales and private transaction module 215, dealer demand module 216 and historical sales transaction module 217. FIGS. 3A, 3B and 3C illustrate the many functions of the title registration module 202. The title registration module 202 is typically used by the research specialist 104, administrator 106, high value asset owner 102, the dealer 103, the insurance provider 105 and the lien holder 108. The title registration module 202 can be accessed at these user respective interfaces.

A typical high value asset owner 102 interface displays information that allows the high value asset owner 102 to register and view the registration information of a high value asset 101. A high value asset owner 102 interface displays a title registry login and verification entry system that allows the owner 102 to verify the registration of a high value asset 101 in the title registry system. Verification requires the entry of the title registry number and the painting password that is in the possession of the registered owner.

FIG. 3A shows an overview of the title registration process. The title registration process begins when a high value asset owner 102/dealer 103 seeks to register the title of his high value asset 101 or a work that a dealer 103 has on consignment and is offering to the international market for sale. A high value asset owner 102 may want to register his ownership interest in the high value asset 101 for a variety of reasons, such as registering the high value asset 101 to have the work properly catalogued and documented, for insurance purposes, lien recording purposes or for the purpose of selling the high value asset 101 in the international fine art market.

In 301 and 302 in FIG. 3, the high value asset owner 102/dealer 103 contacts a research specialist 104 for the purpose of registering the high value asset 101. The research specialist's computer interface contacts the high value asset server 100 to register the high value asset 101. The high value asset owner 101 provides basic details (title, artist name, medium of high value asset, dimension of high value asset, description of high value asset, provenance, ownership documentation, etc.) to the research specialist 104. The research specialist 104 reviews the detailed information for accuracy and/or independently develops the basic details for registering the high value asset 101. Each high value asset 101 that is registered in the high value asset server 100 is identified by a unique registration number. When the research specialist's computer contacts the high value asset server 100, the title registry is searched to check for an existing registration for the high value asset 101. Accordingly, at 304, if the high value asset's 101 unique title registration number is not found, a new entry is created whereby the high value asset 101 is assigned its registration number and unique password designation. If the high value asset's 101 ownership interest has been previously registered, such as in 305, protocol and historical sales information is updated as necessary. After the new title entry is created and saved at 304, historical sales and protocol tabs become available for completing the registration of the high value asset based on the gathering of historical information identified during the provenance review about the high value asset 101.

To register a high value asset 101, a category of painting, sculpture, photography or jewelry is chosen. For a high value asset 101 that is a painting or photograph, information is collected for the following fields: artist; title; description of the subject of the painting; the dimensions in height and width in centimeters or inches; the frame dimensions in height and width in centimeters or inches; type of medium; radio frequency identifier; isotope marker; whether the high value asset is recorded in a catalogue raisonné; field; title owner; physical location of high value asset; password; and associated supporting documents. Types of associated supporting documents that can be added during registration include but are not limited to photographs of the framed view; photographs of the back view; photographs of the front view without frame; catalogue raisonné; condition report; expert reports; provenance preregistration in the title registration system; and restoration reports. If the high value asset 101 is a minor work where no such associated supporting documents exist, then only the photographs (front, back and framed views) are used along with the provenance history prior to the date of registration, according to one embodiment.

For a high value asset 101 that is a sculpture, information is collected for the following fields: artist; title; description of the subject of the painting; the dimensions in height and width in centimeters or inches; type of medium; radio frequency identifier; isotope marker; whether the high value asset is catalogue raisonné; field; title owner; physical location of high value asset; password; and associated supporting documents. Types of associated supporting documents that can be added during registration are photographs of the work, including photography to allow a 360 dimension view of the work; catalogue raisonné; condition report; expert reports; provenance preregistration in the title registration system; and restoration reports. If the high value asset 101 is a minor work where no such supporting documents exist, then the photography (front and 360 dimension capability) is used along with the provenance history prior to the date of registration, according to one embodiment.

For a high value asset 101 that is jewelry, information is collected for the following fields: designer; jewelry type; description of the appearance of the jewelry; stock number; signed; hallmark symbol; certification report; size/length in centimeters or inches; information concerning the stones, if present, including type, shape, weight and color; metal type; purity of metal; title owner; physical location of the high value asset; password; and associated documents. Types of associated supporting documents that can be added during registration are catalogue raisonné; condition report; expert reports; GIA reports; provenance report; preregistration report; and restoration reports.

After the fields are filled, information is recorded about insurance and liens. Information is taken concerning physical condition and the expert or scientific description of the high value asset 101. Some of this information is provided by physical inspection information; black light inspection; security feature protocol; condition inspection; verbal/written description of high value asset; literature; exhibition history; scientific examination; expert examination; expert reports; restoration information; and framing information. Historical sales data of the high value asset 101 can be gathered during the title registration process, which includes date of sale, sale price, comments and the sources of the date. The claim history of the high value asset 101 can be gathered during the title registration process, which includes the date, insurance company, amount and the description.

Upon completion of the registration process at 306, the high value asset owner 102 receives an e-mail with a unique title registry number and password which can be used to log in and view title registry information through a registered user of the system. Following the receipt of the e-mail registration notice, the high value asset owner 102 receives a formal registration card identifying the unique registration number and password as a permanent physical record. After the high value asset 101 registration process is completed, the high value asset 101 is listed for dealer 103, insurance provider 105 and lien holder 108. The registration information regarding high value asset 101 can be modified on high value asset server 100 by an administrator 106, a researcher 104 and/or a business developer 110 after an assessment of the high value asset 101 is complete.

FIG. 3B and FIG. 3C illustrate the viewing function of the tile registration module 202 which allows the high value asset owner 102 and other interested parties to access and view the title registration information on the high value asset server 100. The title registry and the associated title registration information is accessible for viewing by entering the unique registration number and password for a high value asset 101 into the system. The high value asset owner 102, a registered dealer 103, an insurance provider 105 and/or lien holder 108 and any internal user of the system with a corresponding permission or role can access this information. In FIG. 3A at 311, the high value asset owner 102 uses the client computer to access the public title registry login screen.

The high value asset owner 102 logs into the high value asset server 100 using title registry account credentials then enters the unique title registry ID and password into his client computer which contacts the high value asset server 101. If the password is not provided, the user will only see the main picture of the high value asset 101 along with the title and artist information. If the password is correct, the high value asset server 101 responds and displays the title registry page, which includes the registration information and all the historical information known about the high value asset 101, on the client computer of the high value asset owner 102.

FIG. 3C illustrates the viewing function of the title registration module 310 that allows the dealer 103, the insurance provider 105, and/or lien holder 108 to view title registration information. The dealer 103, insurance provider 105 and/or lien holder 108 users log in to a trading platform of the high value asset server 100 using their assigned UserID and password then click on the “Title Registry” and “Title Registry Entry” menu. In the title registry list, the dealer 103, insurance provider 105, and/or lien holder 108 have unique title registry lists based on assigned permissions associated with their respective IDs and passwords for use on the high value asset server 101. As such, the dealer 103, insurance provider 105, and/or lien holder 108 will see only high value assets 101 that the specific entity has either a recorded security interest against the title of the high value asset and/or provides current insurance coverage. In order to view title registration information, the dealer 103, insurance provider 105 and/or lien holder 108 uses his client computer to click on the specific unique registration number to review the title information.

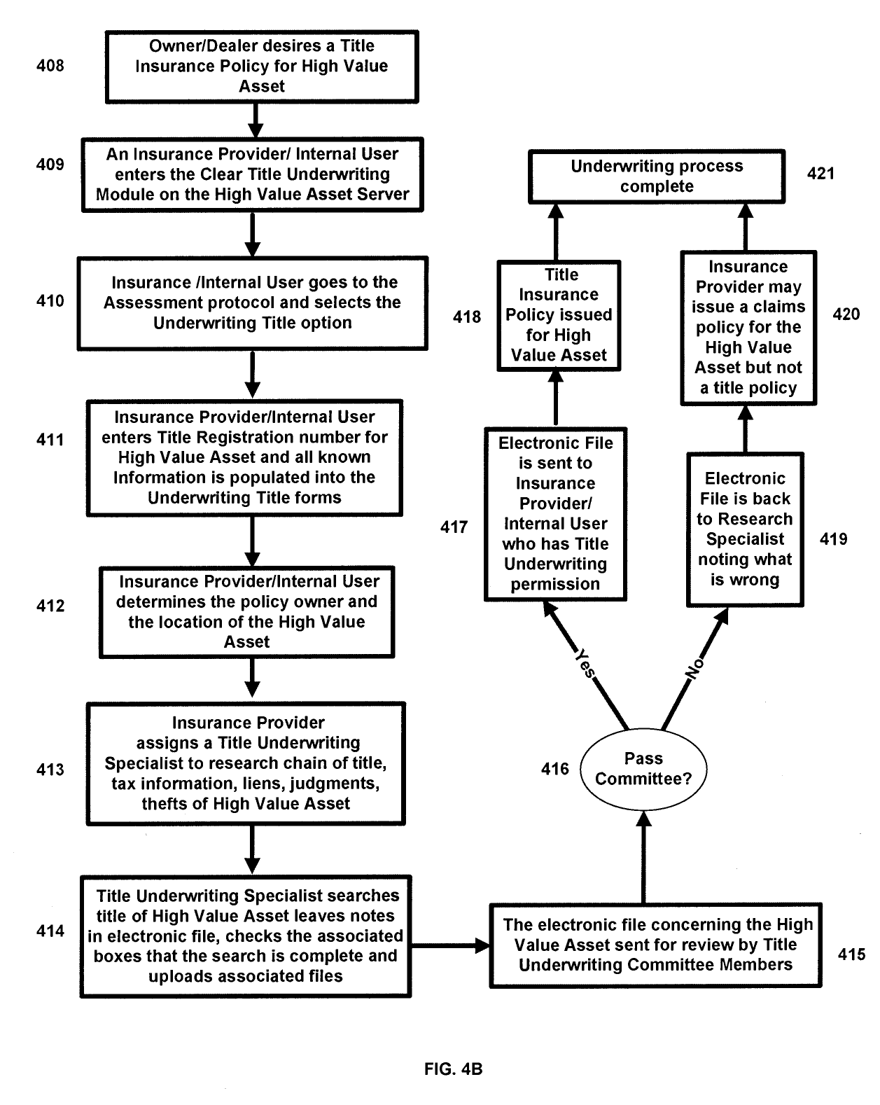

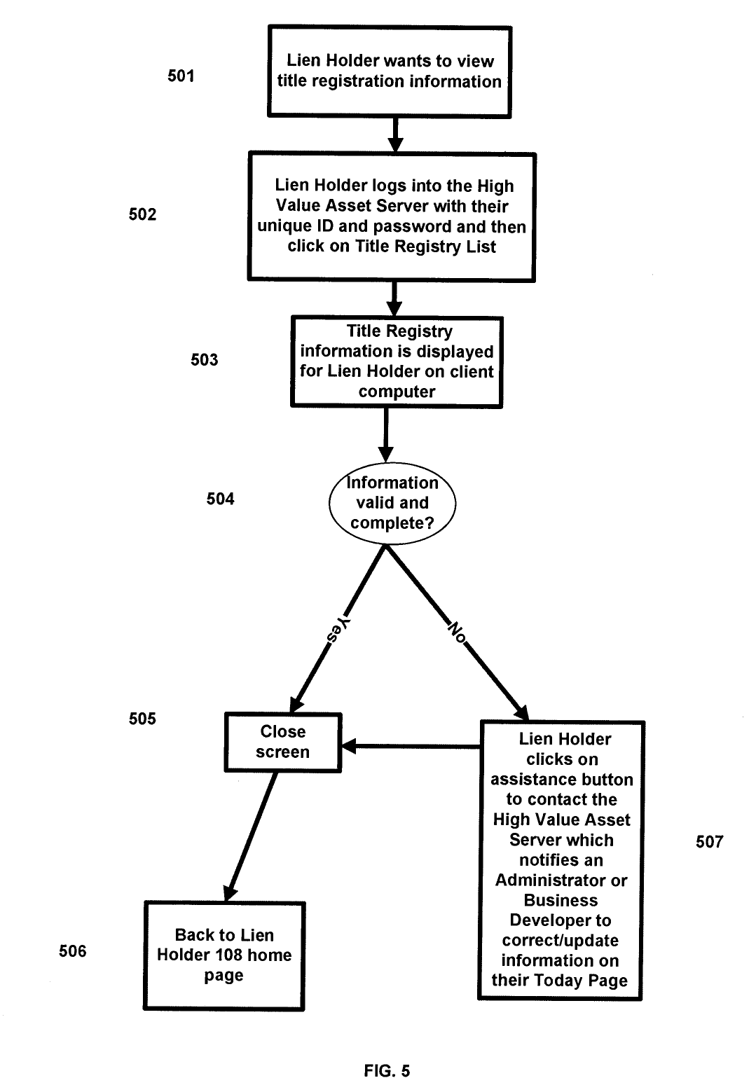

FIGS. 4A and 4B illustrate a flow chart used by the insurance provider 105. FIG. 4A illustrates the flow chart for accessing insurance registration information. Insurance providers 105 interface consists of a Today page, calendar and the tile registry page. The Today page for the insurance provider 105 includes information on the user, role, e-mail and permissions. The calendar page for the insurance provider 105 is where the user can see events associated with the high value asset server 100. The insurance providers 105 have interfaces that contain title lists based on assigned permissions associated with their respective IDs and passwords for use on the high value asset server 101. As such, the insurance provider 105 can only access the insurance records for high value assets 101 that the specific entity maintains has insurance coverage. In order to view the insurance information, the insurance provider 105 uses his client computer to click on the specific unique registration number to review the insurance and title information. The insurance provider 105 can search among these listings with the following parameters: category; number; artist; high value asset name; medium; condition; entry date; owner; fine art insurer; title insurer; lien holder; dimensions; framed dimensions; key words; listed in catalogue raisonné; and stolen.

If the insurance information is not accurate or complete, the insurance provider 105 clicks on an assistance button, and his client computer contacts the high value asset server 101 via system notification to alert an administrator 106 or business developer 110 that the insurance information needs to be corrected or updated. The administrator 106 or business developer 110 then contacts the insurance provider to update and/or correct the insurance information stored on the high value asset server 100 for the respective high value asset 101. If the insurance provider 105 has the proper permissions, the insurance provider 105 can add or modify the information without assistance.

FIG. 4B illustrates a clear title underwriting module process. The clear title underwriting process can be completed by a user that is internal or external to the system. In some instances, the insurance provider 105 may pay an internal user to perform the underwriting process. A high value asset owner 102/dealer 103 is interested in obtaining a title insurance policy 408 on high value asset 101. Thus, the insurance provider 104 or internal user who has the proper permissions for clear title underwriting begins the clear title underwriting process 409. The insurance provider 105 goes to the “Assessment Protocol” menu, selects “Underwriting Title” and clicks “Add new” 410. The insurance provider 105 enters the title registry number of the high value asset 101, and information in the high value asset server 100 for the high value asset 100 appears automatically 411 and populates the underwriting title forms. The insurance provider 105 determines the owner or title policy applicant, who is typically either the dealer 103 or owner 102, and then determines the high value asset 101 location 412. The insurance provider 105 assigns a title underwriting specialist 105B from the same organization that has permission for underwriting 413.

The title underwriting specialist 105B researches chain of title, tax information, liens, judgments and thefts 413. In a protocol tab, the title underwriting specialist 105B can check/uncheck “Clear Title” and “Clear Title Completed” check boxes 414. The title underwriting specialist 105B provides information about export and tax issues and leaves comments concerning clear title review 414. The title underwriting specialist 105B can then check/uncheck the following check boxes: current ownership verified & traced; lien search completed; judgment & litigation search completed; theft search completed; unauthorized export search completed; title insurance application completed 414. The title underwriting specialist 105B uploads the necessary files 414. When the title underwriting specialist 105B finishes, the high value asset appears on underwriting committee members 105A Today's screen 415. The electronic file concerning the high value asset 101 is sent to underwriting committee members 415.

Next, an underwriting committee audit of the underwriting process 416 occurs. Typically, the underwriting committee members 105A are employees of an insurance provider 105, such as a title insurance company. The underwriting committee members 104A are selected by the insurance provider 105 and an administrator 106 sets them up in the system with title underwriting committee user rights. During the underwriting committee audit, the underwriting committee members 105A review the electronic file having relevant information on the high value asset 101 and make the ultimate decision on whether the underwriting passes and a title insurance policy can be issued.

If underwriting passes the underwriting committee audit, a title insurance policy for the high value asset 101 will be issued. After the underwriting passes the underwriting committee audit, this information appears on the Today Page of all users who have permission for title underwriting 417. An insurance provider 105 can issue a title insurance policy and can check the “Title Insurance Policy Issued” check box 418 and press “Save,” and the underwriting process is completed. If the underwriting does not pass the underwriting committee audit, the defects concerning the high value asset 101 will be identified and noted by the underwriting committee. Thus, the insurance provider 105 will not issue a title insurance policy. The insurance provider may offer a claims insurance policy for the high value asset 101.

FIG. 5 illustrates a flow chart of a lien provider module. Lien holders 108 interface consists of a Today page, calendar and title a registry page. The Today page for the lien holder 108 includes information on the user, role, e-mail and permissions. The calendar page for the lien holder 107 is where the user can see events associated with the high value asset server 100. The lien holders 108 have unique interfaces that contain title lists based on assigned permissions associated with their respective IDs and passwords for use on the high value asset server 101. As such, the lien holders 108 will see only high value assets 101 that the specific entity maintains has a recorded security interest against. In order to view title registration information, the lien holder 108 uses his client computer to click on the specific unique registration number to review the title and lien information. The lien holder 108 can search among these listings with the following parameters: category; number; artist; high value asset name; medium; condition; entry date; owner; fine art insurer; title Insurer; lien holder; dimensions; framed dimensions; key words; listed in catalogue raisonné; and stolen.

If the information is not accurate or complete, the lien holder 108 clicks on an assistance button, and his client computer contacts the high value asset server 100 to inform an administrator 106 or business developer 110 on their respective Today Page that the lien information needs corrected or updated. The administrator 106 or business developer 110 then contacts the lien holder to update and/or correct the lien and security interest information stored on the high value asset server 100 for the respective high value asset 101. If the lien holder 108 has required permissions, the lien holder 108 can add or modify the information without assistance.

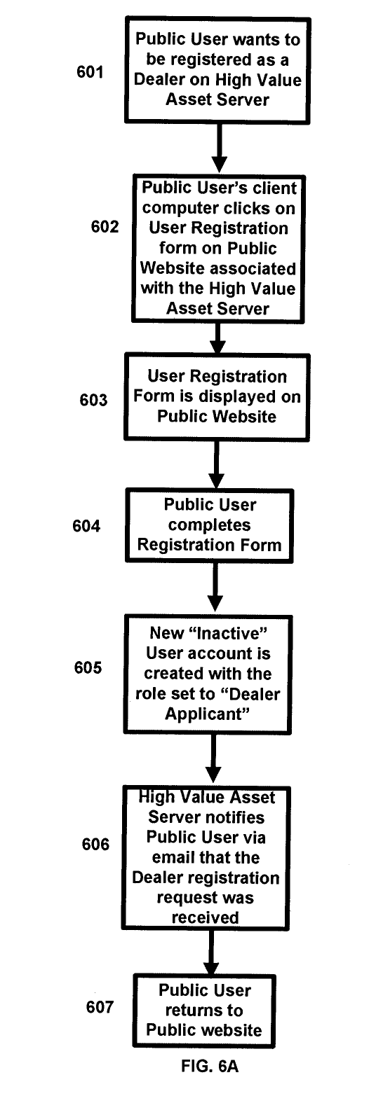

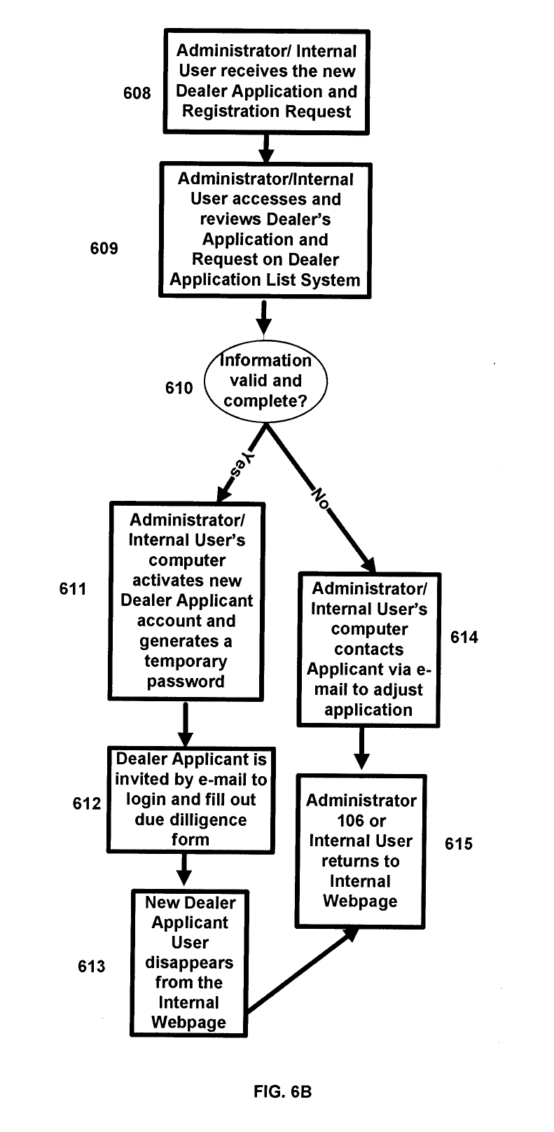

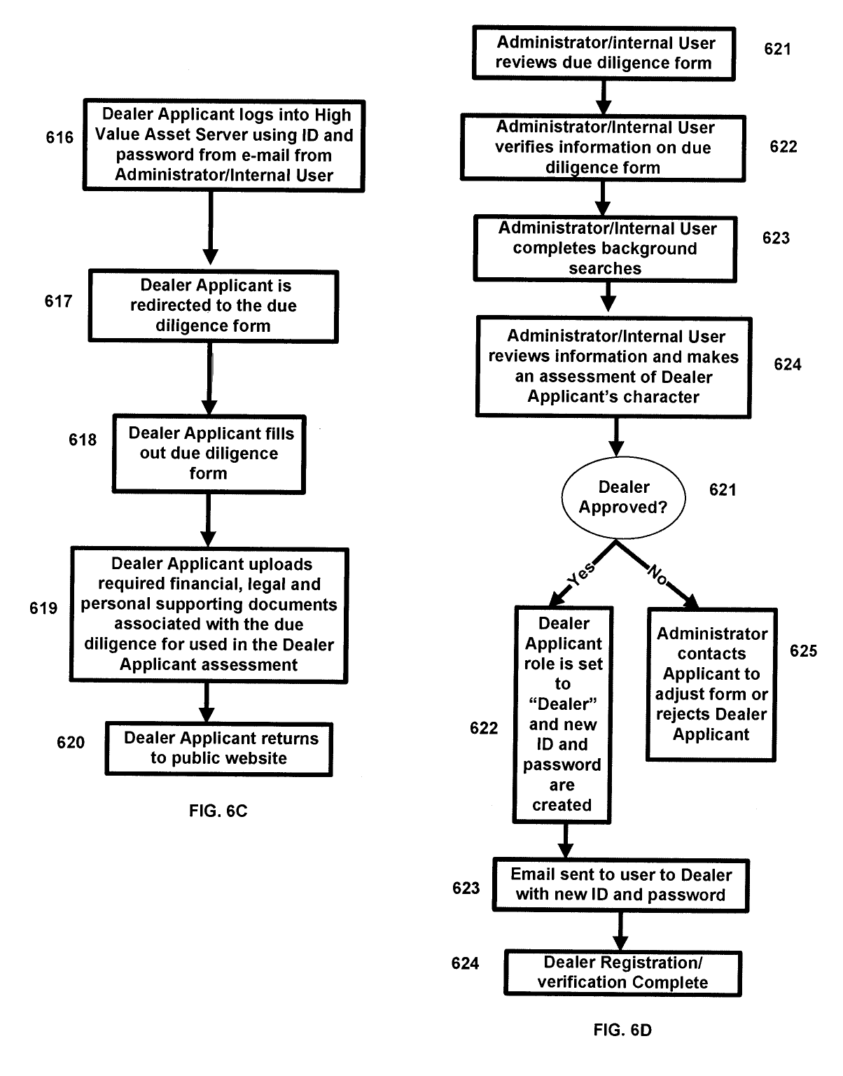

FIGS. 6A, 6B, 6C and 6D illustrate the dealer registration process of the dealer module 203. The dealer module 203 functions to complete the dealer registration process. Dealers 103, also referred to as advisors, are a user role that has access to the system to represent a potential buyer or a high value asset owner. For purposes of the system, the dealer 103 is the only buyer of a high value asset because the true buyer, dealer's client, does not have direct access to the system other than through the dealer 103. After the dealer is registered and verified, the dealer 103 will have an interface that will include information based on permissions and firewalls according to his user roles. A typical dealer 103 interface displays information that allows the dealer 103 to register and purchase high value assets 101. The dealer 103 interface also allows the dealer 103 to interact with external and internal user roles to accomplish these functions. The dealer 103 interface consists of a menu of today page; trading platform page; dealer demand page; sales entry page; a chat page; and messages page.

The Today page of the dealer 103 interface includes user information; calendar; title registry login; high value assets for sale; high value assets under offer; high value assets under option process; and the like. A typical dealer 103 interface displays an events calendar and an option calendar that shows the expiration of the options that have been exercised. A dealer 103 interface displays a title registry login and verification entry system that allows the dealer to verify the registration of a high value asset in the title registry system. Verification requires the entry of the title registry number and the asset password that is in the possession of the registered owner. A dealer 103 interface displays the high value assets 101 for sale, the high value assets 101 for offer and the high value assets 101 under option.

A dealer 103 interface displays the list of assessments on the trading platform owned or represented for sale in the international fine art market by the dealer 103, the list of assessments on the trading platform with active offers that have been made by the dealer 103 and the option requests of the dealer 103 which are not marked as approved, paid in full or canceled. A dealer 103 interface displays transaction audit entries and transactions as well as a list of dealer-made sales transactions submitted by the dealer 103 that have been selected by the system to test for accuracy by a transaction auditor.

The trading platform page of the dealer 103 interface displays the high value asset 101 for sale, trade or options. The trading platform has a list of major markets that a dealer 103 can choose from. Alternatively, on the trading platform page, the dealer 103 can search high value assets 101 by artist; medium; condition; location; price; dimensions; key words; list of countries where the high value asset 101 was created; and theme of the high value asset. The list of the high value asset 101 found by the search includes information about author; title; dimensions; medium; estimated fair market value; price; highest offer; and location.

The demand list page of the dealer 103 interface displays the high value assets 101 the dealer 103 desires to demand and the demand menu options. FIG. 9C illustrates the demand process below.

The sales entry page of the dealer 103 interface displays the history of high value asset 101 sales for the high value asset server 100 and the dealer 103. The dealer 103 can search the sales by the following parameters: high value asset category; artist; artist credentials; mediums; major markets; minor markets; condition; location sold; entry date range; dimensions; frame dimensions; and/or key words. The dealer 103 can also add new high value assets 101 sold to the list by pressing the “Add New” link and adding the following information: organization; dealer; transaction date; title registry number; category; artist; title; description; medium; dimensions; major markets; minor markets; condition; sales price; location sold; and a front view photo of the high value asset 101.

The auction data entry page of the dealer 103 interface displays the list of auction sales. The dealer can view information about the high value asset 101 by clicking on the “Details” link. The dealer 103 can search the auction sales with the following parameters: category; artist; artist credentials; mediums; major markets; minor markets; condition; location sold; entry date range; dimensions; frame dimensions; and/or key words.

The chat and message page of the dealer 103 interface is where the dealer 103 can communicate with other users. On the chat page, the dealer 103 can chat with other users online if there is an active chat. The message page displays a list of messages the dealer 103 sent and received. The dealer 103 can search the messages.

FIGS. 6A, 6B, 6C and 6D illustrate the dealer registration process of the dealer module 203. The fine art dealer 103 registration request submission begins the dealer registration process in the dealer module is depicted in FIG. 6A. The fine art dealer 103 registration request review of the dealer registration process of the dealer module and is depicted in FIG. 6B. FIG. 6C demonstrates how the dealer user logs in to the present system and completes the required due diligence form. FIG. 6D demonstrates how the due diligence form is reviewed and how a fine art dealer user applicant is promoted to a dealer status with system access, if approved.

The fine art dealer registration request submission process is depicted on the flow chart of FIG. 6A. The process begins at 601 when the public user wants to be registered as a dealer 103 on the high value asset server 100. A public user, a fine art dealer user, visits a public Web site associated with the high value asset server 100, and from a “Dealer Services” page, the fine art dealer user clicks “Start Registration Process” 602. The high value asset server 100 responds by displaying the “User Registration Form” on the public Web site 603. The public user is redirected to the dealer registration page and fills in all certain information (name, organization, markets of interest, etc.). When the user submits it by pressing the “Submit” button, a new record is saved to the database 604. At this point a new account is created on the high value asset server 100 with a temporary UserID, assigned a “Dealer Applicant” role and marked as “Inactive” 605. The high value asset server 100 responds to the creation of the account, and the public user is sent an e-mail notification that the registration form has been received 606.

FIG. 6B illustrates a fine art dealer registration request review process, according to one embodiment. An administrator 106 (or internal user) receives a new dealer application on the internal Today Page 608. An administrator 106 or internal user reviews the dealer user's request for registration on the internal dealer application list system site 609. The administrator 106 (or internal user) checks to see if the information is complete and valid 610. If the information is valid and complete, the administrator 106 checks the “Is Active” checkbox and generates a temporary UserID and password 611, and the dealer applicant is sent an e-mail notification that contains login credentials. The dealer applicant is invited by e-mail to log in and fill out the due diligence form 612. If the information is not valid and/or complete, the administrator 106 contacts the dealer applicant by computer via e-mail to adjust the application 614.

The completion of the due diligence form by the fine art dealer is depicted in the flowchart of FIG. 6C. After a dealer applicant receives an e-mail notification, the dealer applicant logs in to the high value asset server 100 using the temporary credentials (UserID and password) provided with the administrator's 106 e-mail message 616. After logging in, the dealer applicant is redirected to the due diligence form 617, which he fills in and submits to the system 618. A dealer applicant must be approved to be a dealer in the system. The due diligence form assists in the character assessment of each of the dealer applicants. The due diligence form requests personal, financial and legal information concerning the dealer applicant. For example, a dealer applicant is requested to provide information such as, but not limited to, historical financial statements, a list of personal and professional references and the identity of their legal counsel and accountants.

The review of the fine art dealer's due diligence form is depicted in the flow chart of FIG. 6D. An administrator 106 or internal user reviews the completed fine art dealer due diligence form. After the information is provided, an administrator/internal user reviews the financial information to determine financial stability, as well as perform litigation searches, background searches and lien searches on the dealer applicant. After the information provided is verified and the respective searches are complete, an administrator or an internal user or panel reviews all the known information on the dealer applicant and makes a final determination if the dealer applicant meets the character standard for admission to be a user on the system. If the dealer applicant meets the character standard and is approved, the dealer applicant's registered user account is updated and assigned a user role of “Dealer” and given a new UserID and password 622. If the information is not valid and/or complete, the administrator 106 contacts the dealer applicant to adjust the due diligence form or makes a rejection of the dealer applicant.

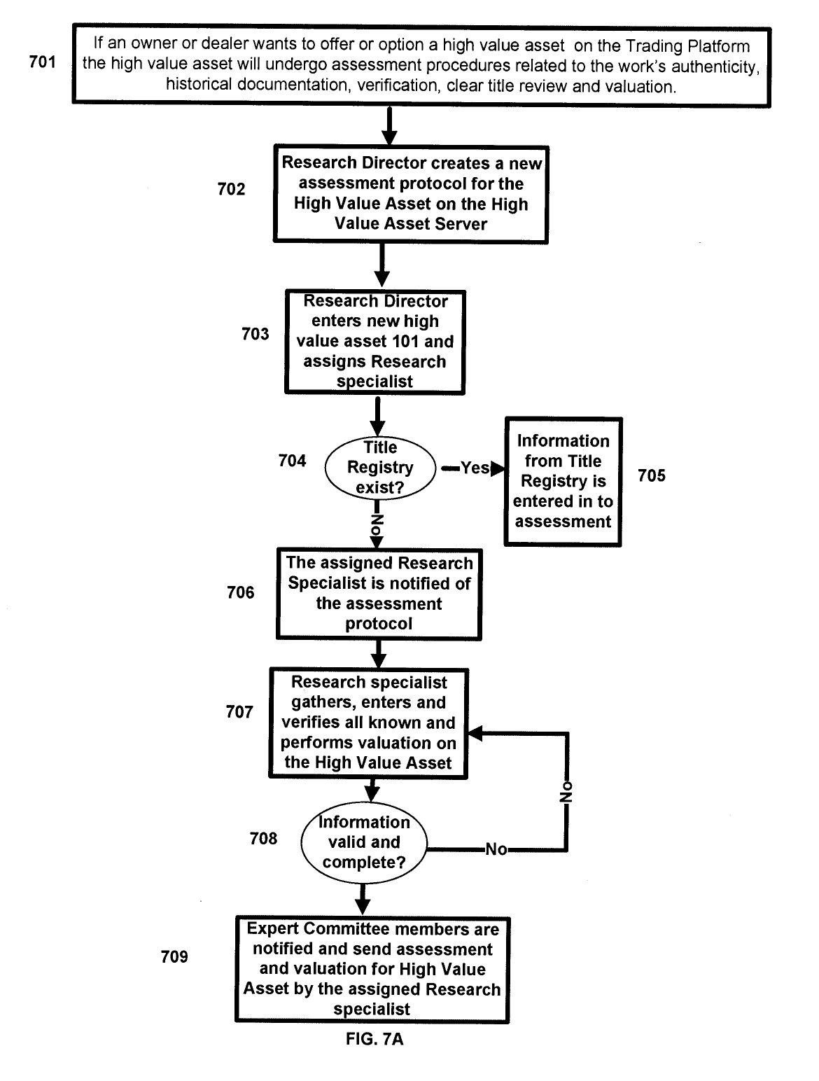

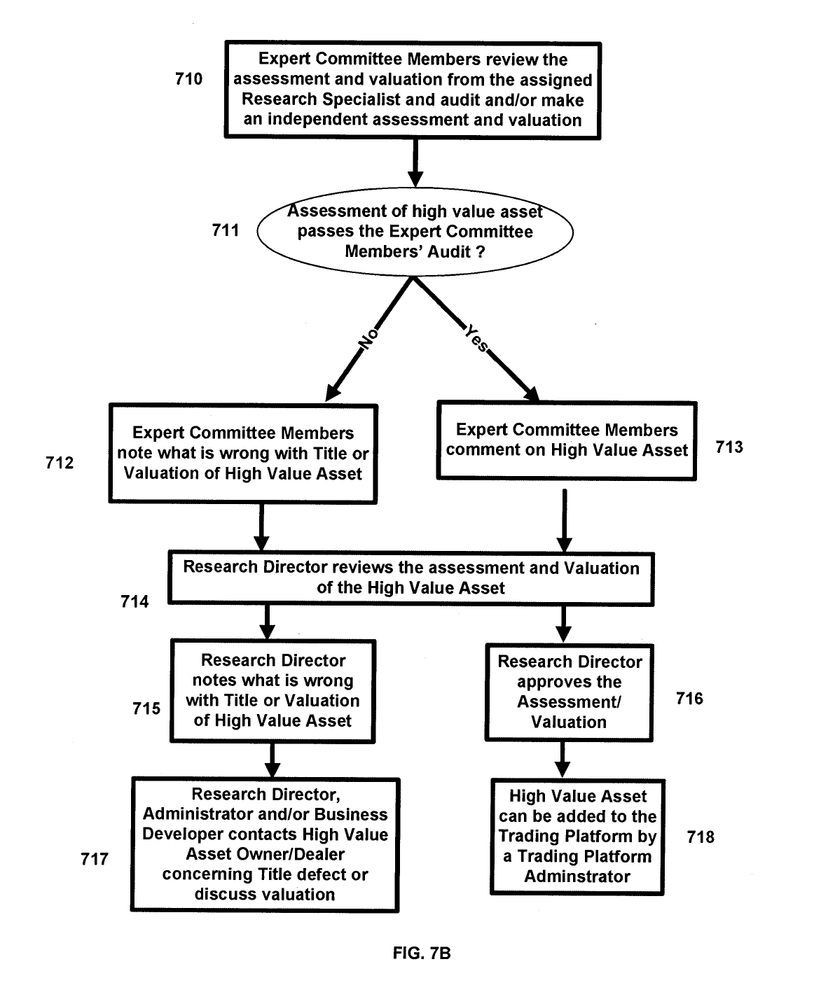

FIGS. 7A and 7B depict the assessment protocol and valuation module in which assessments are made related to the authentication, valuation and sale of the high value asset 101. If an owner 102 or dealer 103 wants to offer or option a high value asset 101 on the trading platform, the high value asset will undergo assessment procedures related to the high value asset's authenticity, historical documentation, clear title, verification and valuation. There are three user roles associated with the assessment protocol and valuation module: the researcher 104, the research director 104A and the expert committee member.

A typical research specialist 104 interface displays information that allows the research specialist 104 to authenticate and valuate high value assets 101 that will be placed on the trading platform for offer or option. A typical research specialist 104 interface also allows the research specialist 104 to interact with external and internal user roles to accomplish these functions. A typical research specialist 104 interface displays the high value assets 101 under assessment that are assigned to the respective research specialist, categorizing him as a primary or secondary research specialist. The assessments displayed are those assessments that have been assigned but not been approved, and rejected and not listed on the trading platform assessments.

The Today Page of the research specialist 104 interface includes user information; a calendar; high value assets under editing and off the trading platform; all high value assets under assessment; high value assets requiring research director approval; and high value assets awaiting upload to trading platform. A typical research specialist 104 interface displays an event calendar. A research specialist 104 interface displays all high value assets 101 under assessment that have been assigned and not approved and rejected and not listed on trading platform assessments with status not equal to complete. A research specialist 104 interface displays the high value assets 101 awaiting upload to the trading platform and approved assessments not yet listed on the trading platform. A research specialist 104 interface displays high value assets 101 requiring research director approval and yet unapproved assessments that have complete status. A research specialist 104 interface displays high value assets 101 under edit and off trading platform and all assessments as removed from trading platform except for those removed as unsold and approved by the research director already.

The entry page of the interface of the research specialist 104 displays the list of artists and jewelry designers that are registered in high value asset server 101. The research specialist 104 can add a new artist or designer by clicking on Add New and filling in the following: name, artist life period, nationality, categories, country of affiliation, major markets, minor markets, alternative names, credentials, catalogue raisonné, indication of whether the author or designer is still active and upload of the respective files. The research specialist 104 can search among the registered artists within the parameters of: artist name, nationality, life period, artist credentials, major markets and minor markets. The assessment protocol page of the interface of the research director 104A displays assessment protocols, and the research specialist 104 can search among assessment protocol and add new assessments.

The sales entry page of the interface of the research specialist 104 displays dealer data entries and auction data entries, and the research specialist 104 can search and add new entries. The trading platform page of the interface of the research specialist 104 displays the high value assets 101 on the trading platform.

The chat and message page of the research specialist 104 interface is where the research specialist 104 can communicate with other users. On the chat page, the research specialist 104 can chat with other users online if there is an active chat. The message page displays a list of messages the research specialist 104 sent and received. The research specialist 104 can search the messages.

A typical research director 104A interface displays information that allows the research director 104A to draft and assign a protocol for authenticating and valuating high value assets 101 that will be placed on the trading platform for offer or option. A typical research director 104A interface also allows the research director 104A to interact with external and internal user roles to accomplish these functions. The typical research director 104A interface consists of a menu of: Today Page; entry; title registry; assessment protocol; trading platform page; sales entry page; a chat page; and messages page.

The Today Page of the research director 104A interface includes: user information; calendar; high value assets under editing and off the trading platform; all high value assets under assessment; high value assets requiring research director approval; and high value assets awaiting upload to trading platform. A typical research director 104A interface displays an event calendar. A research director 104A interface displays all high value assets 101 under assessment that have been assigned and not approved and rejected and not listed on trading platform assessments with status not equal to complete. A research director 104A interface displays the high value assets 101 awaiting upload to the trading platform and approved assessments not yet listed on the trading platform. A research director 104A interface displays high value assets 101 requiring research director approval and yet unapproved assessments which have complete status. A research director 104A interface displays high value assets 101 under edit and off trading platform and all assessments as removed from trading platform except for those removed as unsold and approved by the research director already.

The entry page of the interface of the research director 104A displays the list of artists and jewelry designers that are registered in high value asset server 101. The research director 104A can add a new artist or designer by clicking on add new, and filling in the following: name, artist life period, nationality, categories, country of affiliation, major markets, minor markets, alternative names, credentials, catalogue raisonné, indication of whether the author or designer is still active and upload of the respective files. The research director 104A can search among the registered artists within the parameters of: artist name, nationality, life period, artist credentials, major markets and minor markets. The assessment protocol page of the interface of the research director 104A displays assessment protocols, and the research director 104A can search among assessment protocol and add new assessments.

The sales entry page of the interface of the research director 104A displays dealer data entries and auction data entries, and the research director 104A can search and add new entries. The trading platform page of the interface of the research director 104A displays the high value assets 101 on the trading platform.

The chat and message page of the research director 104A interface is where the research director 104A can communicate with other users. On the chat page, the research director 104A can chat with other users online if there is an active chat. The message page displays a list of messages the research director 104A sent and received. The research director 104A can search the messages.

Expert committee members 104B are individuals that are high value asset dealers and/or have a substantial expertise and background in high value assests that have been selected by the high value asset system's management to provide independent oversight of the entire assessment protocol and valuation process. Typically, an expert committee member 104B is an independent contractor. A typical expert committee member 104B interface displays information that allows the expert committee member 104B to evaluate completed assessment protocols for authenticating and valuating high value assets 101 that will be placed on the trading platform for offer or option. A typical expert committee member 104B interface also allows the research director 104B to interact with external and internal user roles to accomplish these functions. A typical expert committee 104B interface displays the high value assets 101 available for approval and a list of complete and approved-by-research director assessments requiring a current user's vote as a committee member.

The assessment protocol and valuation module in FIG. 7A begins when a high value asset owner 102 wants to place a high value asset 101 on the trading platform. A research director 104A creates a new assessment protocol for the high value asset 101 on the high value asset server 100 (702). The research director 104A enters the high value asset's unique title registry number. If title registry exists, all existing information from the title registry is loaded into the assessment protocol system 703. The research director assigns primary and secondary researcher/research specialists 104 and business developers 110 to the assessment protocol. The research specialists 104 and business developers 110 receive a system notification on their respective Today Page that they were assigned to the new assessment protocol 706. At this point, the assessment receives a status of “Assigned” in the high value asset server 100.

The primary and secondary research specialist 103 and business developers 110 enter all the information known about the high value asset 101 and follow the assessment protocol tabs 707. The information concerning the high value asset 101 that is entered includes but is not limited to the artist, the owner, the location, the sales history, the major and minor assigned markets and the like. The primary and secondary research specialist 103 and business developers 110 upload all the historical files related to ownership and authentication. The primary and secondary research specialist 103 and business developers 110 complete assessment, authentication and valuation procedures. Some of the assessments of the high value asset 101 are provided by physical inspection; black light inspection; security feature protocol; condition inspection; verbal/written description of high value asset; literature; exhibition history; scientific examination; expert examination; expert reports; restoration information and framing information. For example, when the research specialist 104 makes an assessment of the high value asset 101, all documentation on a high value asset is obtained and verified for accuracy, the provenance is reviewed and traced, the condition of the high value asset is inspected, clear title is verified and valuation of the high value asset is completed.

In general the valuation of a high value asset 101 is completed by a research specialist 104 or internal user. The valuation of the high value asset is typically done by comparing the high value asset to other high value assets by the artists that have sold in the market and modifying that valuation based on the uniqueness of the individual work and the demand for that work in the market. The data from the auction sales and private transaction module 215 and the dealer demand module 216 and historical sales transaction module 217 is used to compare the value of the high value asset to other known sales and existing demand. These modules have search engines to shorten the time to find the most comparable work. These modules have graphing features and filters that allow the internal user to perform the valuation and incorporate the valuation into the assessment protocol and valuation module. The valuation opinions of the various internal users and the descriptions of how the value was derived is documented and uploaded in the system.

According to one embodiment, as soon as items are complete in the protocol, the assessment and valuation gets the status of “Complete.” The assessment becomes available for approval voting by expert committee members 104B, and it is listed on their Today Page associated with their interface, as shown in FIG. 7B. The assessment and valuation of the high value asset 101 is reviewed by the expert committee members 104B (710). The expert committee members 104B can audit the assessment and valuation, as well as make an independent assessment and valuation. After reviewing the assessment and valuation, the expert committee member 104B has options to (i) vote positively and provide any relevant comments on assessment protocol and valuation procedures; (ii) vote negatively and provide any relevant comments on assessment protocol and valuation procedures or (iii) abstain and provide any relevant comments on assessment protocol and valuation (711, 712, 713). After an expert committee member 104B votes and saves the assessment protocol entry, the system checks if all expert committee members 104B have voted. If they did, it counts the number of positive and negative votes. If total voting is positive, the assessment shows up on a research director's today page under “Works Requiring Research Director Approval.” Otherwise, it's marked as rejected.

The research director 104A reviews assessment and valuation for the high value asset 101 by the assigned research specialist 104 and expert committee members 104B (714). If the assessment and valuation is approved, the high value asset 101 can be listed on the trading platform by a trading platform administrator 106A. If the assessment and valuation was rejected by the expert committee members 106B, the research director 106A notes what is wrong with the title or valuation of the high value asset 101. It is rare that the assessment and valuation protocol is rejected; the rejection would stem from a defect in title or from dispute in valuation. If the assessment protocol is rejected, an internal user such as the research director 104A, an administrator 106 and/or business developer 110 contacts high value asset owner 102/dealer 103 to discuss the defect in title or discuss value of the high value asset 101. If it is rejected, then the high value asset may have some title defect that makes the high value asset 101 unsellable on the market, such as the high value asset is a fake or was stolen. If the high value asset was stolen, it will be recorded as stolen. The system also has a function that sends alerts if a high value asset is reported as stolen in the history of high value asset 101 within the high value asset server 100. Alternatively, the assessment protocol may be rejected due to the difference in opinion on value of the high value asset that cannot be resolved during the protocol and/or audit. In the case of the rejection due to the valuation of the high value asset, a business developer 110 or internal user collaborates with the high value asset owner 102/dealer 103 to price the high value asset 101 before placing the high value asset 101 on the trading platform.

After an assessment has received the status “Approved,” a research specialist 104 or the research director 104A is able to place it on the trading platform. A research specialist 104 opens a trading platform entry page. If the high value asset 101 needs to be sold as part of a set of high value assets (two or more other high value assets by the same artist), a research specialist 104 adds required high value assets 101 to the set. If options need to be allowed for the high value asset, a research specialist 103 checks a corresponding checkbox on the trading platform entry page. The estimated fair market value (“FMV”) is specified based on valuation procedures performed and documented in the assessment protocol system. As stated previously, a fair market value calculation is dependent on numerous considerations, which include artist, subject matter, prior comparable sales transactions (auction sales, private sales and prior systems sales), condition, provenance and of demand factors. The estimate of FMV is documented in the high value asset server 100. The documentation of FMV includes the basis of the valuation, such as the comparable transactions (auction, private sales and prior system sales) included in the analysis and the existence of a demand from known sources for the work. The research specialist 104 can check the “List on the trading platform” checkbox on his trading platform page in the trading platform module, and the entry is saved. After the entry is saved, the high value asset becomes available on the trading platform.

When a high value asset is listed on the trading platform, the approved assessments are locked for editing. In order to edit changes, a research specialist 103 with proper internal user rights or a research director 104A unchecks a “List on TP” checkbox and sets the reason of withdrawal to “Editing,” and the high value asset 101 is removed from the trading platform. The research director's 104A interface will have these high value assets 101 under the heading of “Works Under Editing” and “Off the trading platform.” After changes/updates are made, a research director reapproves the assessment, and a research specialist 104 or research director 104B can put it back on the trading platform.

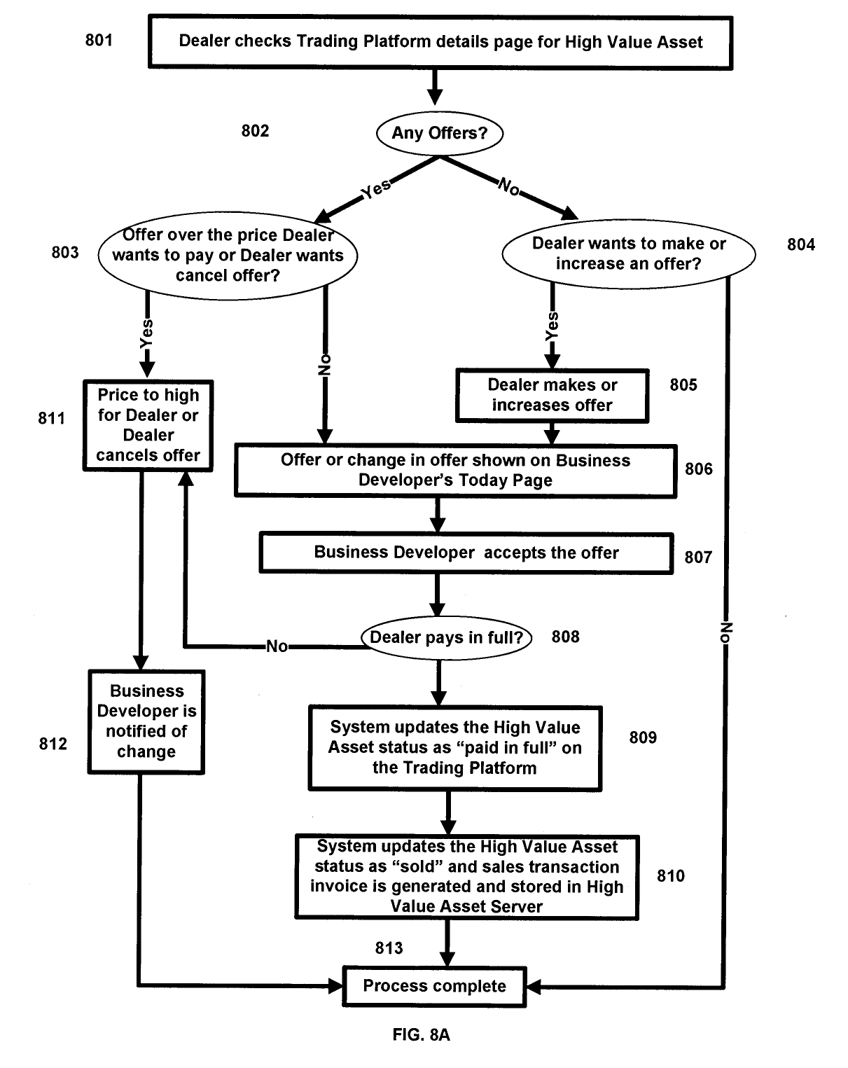

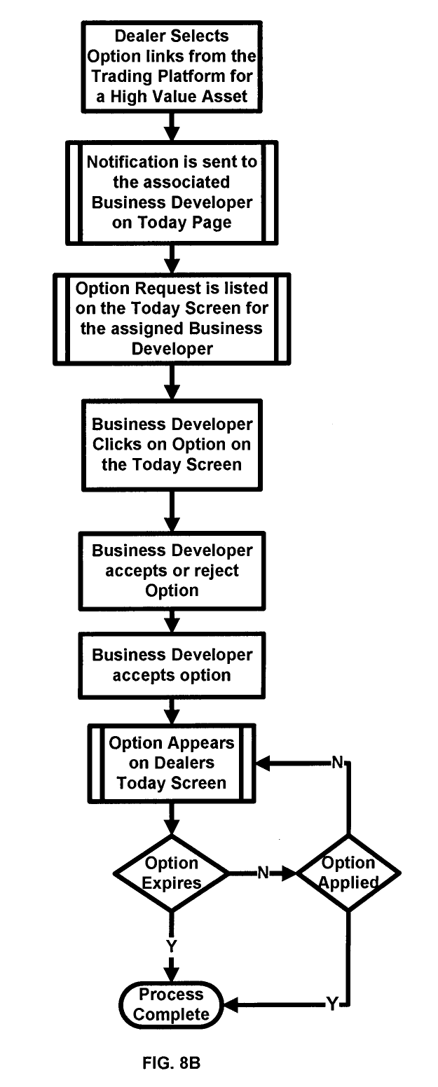

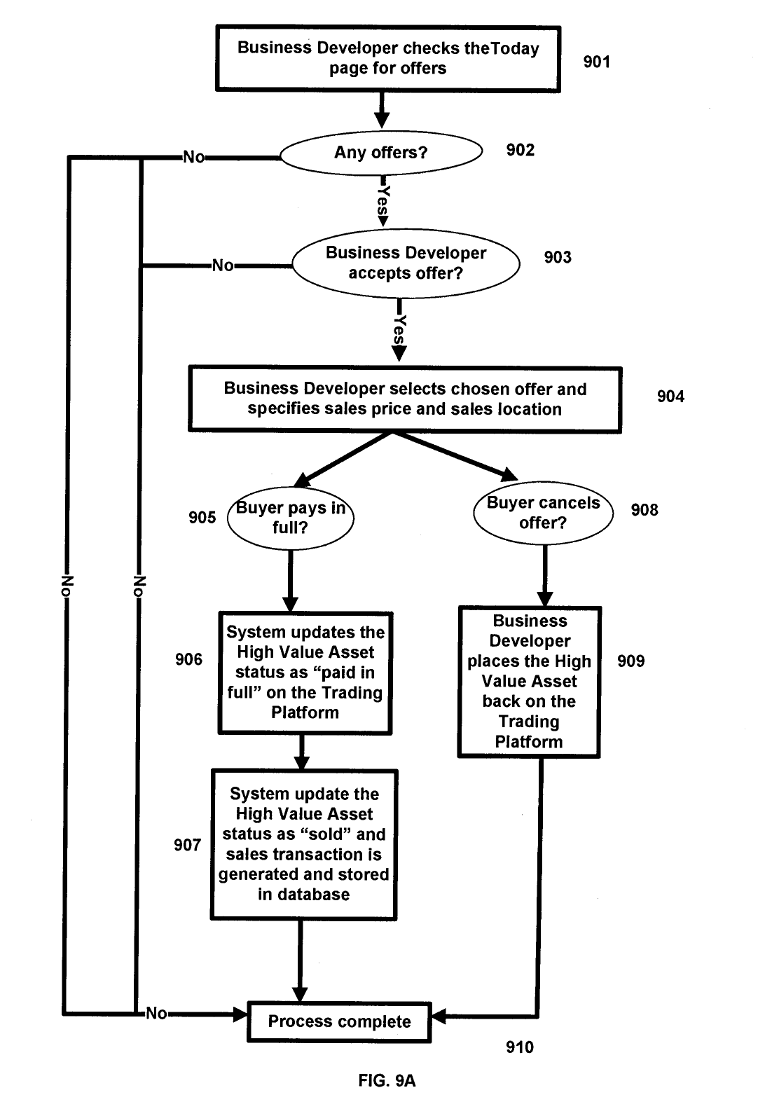

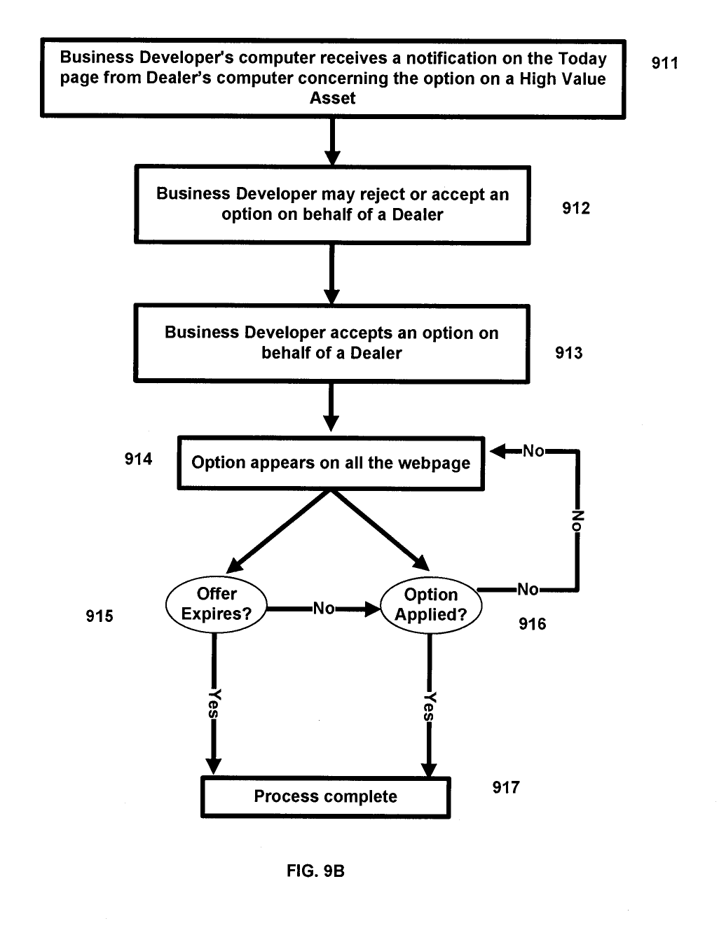

FIG. 8A, FIG. 8B, FIG. 9A, FIG. 9B and FIG. 9C illustrate processes associated with the trading platform module. The processes associated with the trading platform are overseen by the trading plafform administrator 106A. The trading platform administrator 106A is a user right that is assigned to certain research specialists 104, including the research director 104A. A trading platform administrator 106A is a user who oversees and performs entering the high value asset 101 onto the trading platform after it is approved by the expert committee members 104B and the research director 104A. A trading platform administrator 106A enters the FMV approved by the expert committee members 104B for the high value asset 101 that will appear on the trading platform. A trading platform administrator 106A assigns any options that are available for the high value asset 101. A trading platform administrator 106A enters the “key word” descriptions specific to that high value asset 101 to assist the key word search engine functionality. The trading platform administrator 106A is the only user authorized to remove a high value asset 101 from the trading platform. Also, an internal user from the accounting department has trading plafform administrator rights to perform the final invoicing for high value asset 101 that are sold, and the invoices are generated from the system. The actual invoicing and financial services in addition to the sales price that may be due will be performed by the accounting person with trading plafform administrator rights.

The trading platform administrator 106A interface consists of a menu of Today page; assessment protocol; trading platform page; a chat page; and messages page. The Today page of the trading plafform administrator interface contains user information, calendar, and status of high value assets under assessment. The high value assets under assessment page displays the active assessments so the trading platform administrator 106A can watch their status. The trading platform administrator 106A can view more information concerning assessments by clicking on the “Details” link.

The trading plafform administrator 106A can control the listing of high value assets on the trading platform from the assessment and Trading Platfom pages. The trading platform administrator 106A can sell high value assets 101 in sets, include high value asset 101 in premium high value assets, allow options for a high value asset 101 and take a high value asset off the trading platform. High value assets 101 can be sold as a set if the high value asset 101 was created by the same artist or designer as the others in the set and the other high value assets 101 in the set have not been placed on the trading platform previously. To sell a high value asset 101 in a set that is not currently on the trading platform, the trading plafform administrator 106A can check “Allow to Be Used in Work Sets,” and the high value asset 101 can be placed on the trading plafform with other ones as the set. To sell high value assets 101 in a set that is currently on the trading platform, the trading platform administrator 106A can click a link, and trading platform entry form will be opened. If check box “Allow to Be Used in Work Sets” was checked on assessment protocol, there will be “Work Set Management” tools. The trading platform administrator 106A can include other high value assets 101 in the set. The trading platform administrator 106A can take high value assets off the trading platform by checking/unchecking “List Work on the trading plafform.” If the trading platform administrator 106A unchecks this check box, trading platform administrator 106A is prompted to select the reason why the high value asset 101 is being taken off the trading platform. These reasons include for editing or that the high value asset has been sold or is unsold after the offer period. If the high value asset 101 was sold, the trading platform administrator 106A should select the offer and indicate who bought the high value asset 101, sale location and sale price.

FIG. 8A illustrates a flow chart of a trading platform module for the dealer making an offer for a high value asset 101. The dealer 103 views a high value asset on the trading platform. If he wishes to purchase it, the dealer 103 makes an offer by specifying a price he wants to pay and clicks the “Make an Offer” button on the high value asset's 101 details page 805. After the dealer submits an offer, it is displayed on a business developer's page 806. The business developers 110 assist in the offer process, as shown in FIG. 9A. Any conditions of the offer made by a dealer 103 are communicated directly to the assigned business developer 110 for the high value asset 101 via an integrated “chat” or “message” feature incorporated into the system.

The dealer 103 can view the status of his offer and all other competing offers in real time on his Today Page and can also monitor the offering process and list of all offer prices made on the high value asset. The system provides notification to the business developer 110 on his Today Page that the a dealer 103 has either increased his offer. The system also provides notification to the business developer 110 on their Today Page that the price of the high value asset 101 is above the price the dealer 103 will pay. The notification on the Today Page is that the dealer 103 has dropped off the system by removing his offer. If a dealer wants to cancel his offer, he can view the high value asset details page on the trading platform and click the “Cancel Offer” button 811. The offer is then removed from the system, and the business developer 110 is contacted. The business developer 110 places the high value asset 101 back on the trading platform to receive other offers or options. If the offer is accepted and the dealer 103 pays in full, the system updates the high value asset 101 status as paid in full on the trading platform. The system also updates the high value asset 101 status as sold, and the sales transaction is generated and stored in the high value asset server 100.

FIG. 8B illustrates a flow chart of the trading platform module for the dealer making an option for a high value asset 101. If options are allowed for the high value asset on the trading platform and the assessment is not under any current offers, the option links are visible on the trading platform details page. If a dealer 103 wants to option a high value asset 101, the dealer 103 clicks on an option link associated with a high value asset 101 on the trading platform module 814. The dealer 103 provides the start date of the option, the end date (if not predefined) and the preferred way of payment 815. After the dealer 103 submits, the option request is displayed with “New” status 816 on the assigned business developer's interface under the “Option Requests from Dealers” list.

As shown in FIG. 8B, the option can be accepted by a business developer 110 on behalf of a dealer 103. The business developer 110 either “approves” or “rejects” the option request by a dealer 103. After it is accepted, the system sends an invoice to the dealer 103. When accepted the option, the option becomes active 825, and the dealer 103 then has a defined time period to have the exclusive right to sell the high value asset 101. The dealer 103 can apply the option and proceed with the purchase 827 if the high value asset 101 is sold within the option period.

FIG. 9A illustrates a flow chart of the marketing module where the business developer assists with the offer process for a high value asset. A typical business developer's 110 interface displays information that allows the business developer 110 to provide oversight and assistance with the sale or trade of the high value asset 101 and also allows the business developer 110 to interact with each of the internal and external user roles associated with the transaction. A typical business developer's 110 interface displays an events calendar and an option calendar that shows the status of the options that have been requested by dealers 103 but have not yet been accepted. A typical business developer's 110 interface displays high value assets 101 under assessment and those assigned to the respective business developer 110 that are not listed on the trading platform, not approved and not rejected. A typical business developer's 110 interface displays high value assets 101 assigned to the respective business developer 110 that are not marked as canceled or paid in full, and include assessments assigned to the current user as primary or secondary business developer. A typical business developer's 110 interface also displays a list of assessments assigned to the business developers 110 as primary or secondary business developer 110 listed on the trading platform.

When the business developer 110 assists with the offer process for the high value asset 101 in FIG. 9A, the business developer 110 begins by checking the Today Page for offers 901. The business developer's Today Page summarizes all works with offers. The business developer 110 does not interface with the actual trading platform system for monitoring and/or initiating the sales effort. If the business developer 110 accepts an offer on behalf of a dealer 103, the business developer 110 selects and chooses the offer and specifies sales price and sales location. When the dealer 103 pays in full for the high value asset 101, the system updates the high value asset status as “paid in full” on the trading platform 906. Next, the system updates the high value asset status as sold, and a sales transaction is generated and stored in the database 907. If the dealer 103 cancels the offer, the business developer 110 places the high value asset back on the trading platform.

FIG. 9B illustrates a flow chart of the marketing module where the business developer assists with the option process for a high value asset. When a dealer 103 wants to exercise an option, the internal computer of the business developer 110 receives a system notification on their Today Page 911. The option can be accepted by a business developer 110 on behalf of a dealer 103 (912). The business developer 110 either approves or rejects the option request by a dealer 103. After it is accepted, the system sends an invoice to the dealer 103. When the option is accepted, the option becomes active 825, and the dealer 103 then has a defined time period to have the exclusive right to sell the high value asset 101. The dealer 103 can apply the option and proceed with the purchase 827 if the high value asset 101 is sold within the option period. No status of the option appears on the trading platform. Internal users have an options list that summarizes all works under option and when those options expire. All works under option are hidden on the trading platform from all other dealers 103 except the dealer 103 with the exclusivity option.

FIG. 9C illustrates a flow diagram for the dealer demand process. The dealer demand segment of the system matches the supply and demand for the market. The dealers 103 that provide dealer demand information on high value assets 101 and artists receive priority treatment when the demanded high value assets 101 are identified. The dealer 103 clicks dealer demand menu option 920. The dealer 103 enters data into a dealer demand entry form 921. When the dealer adds the demand, the dealer 103 enters the title registry number of a similar high value asset 101, dealer 103 comments, checks the high value asset 101 category and adds general information, the artist name, description of the high value asset 101, medium, dimensions, condition and price. The dealer 103 can then begin to search among the demanded high value asset 101. If a dealer 103 updates his demand later, all internal users receive a notification with information on the original and the updated demand. The business developer 110 clicks dealer demand list 924. The dealer demand entries for all dealers in the system are available for view by business developers 925.

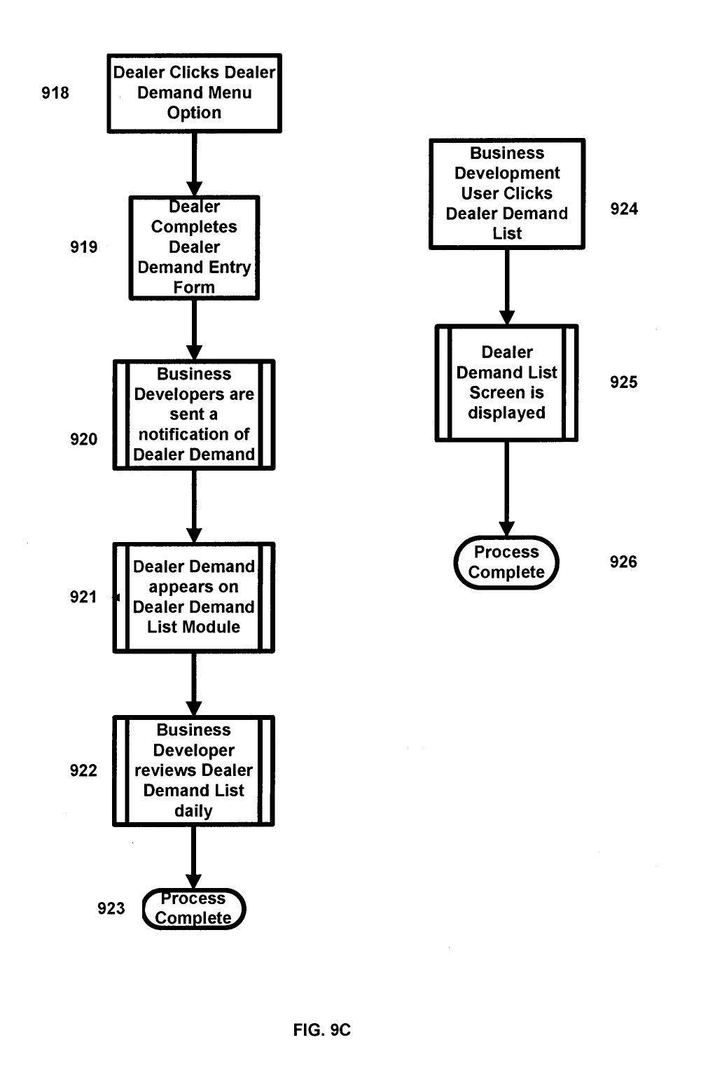

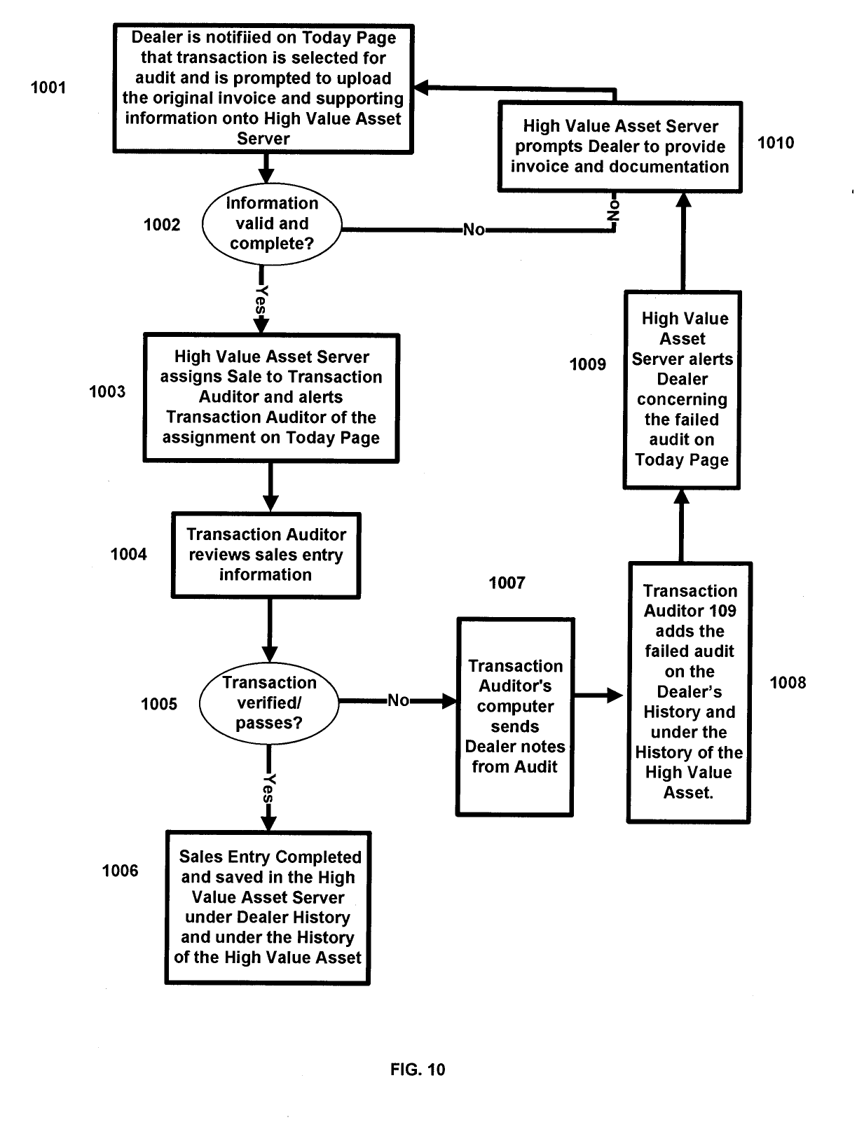

FIG. 10 illustrates a flow chart of the sales transaction audit module. The sales transaction auditor is a “user right” that is assigned to one of the research specialists 104. A typical sales transaction auditor 109 interface displays information that allows the transaction auditor 109 to access the transaction audit module to provide oversight and evaluation of the private dealer sale transactions of the high value asset 101. It also allows the transaction auditor 109 to interact with each of the internal and external user roles associated with the transaction. A typical transaction auditor 109 interface displays an event calendar and the list of dealer 103 entered sales transactions whose entry information has been selected for sampling accuracy and for which supporting information has not yet been provided.

In FIG. 10, the system automatically selects a transaction for an audit. After a transaction is selected, the dealer 103 involved in the transaction is notified on his Today Page that the transaction has been selected for an audit. The dealer 103 is alerted that the original invoice and supporting documents concerning the sales transaction is uploaded into the system for review 1001. The dealer 103 uploads data concerning the private sale of a high value asset 101 onto the high value asset server 100 (1001). If the high value asset 101 is registered in the title registry and the user/dealer knows its number, the number is entered, and available data is loaded into the form automatically. If the entry is not complete, the high value asset server 101 prompts the dealer 103 to complete all fields and files 1009. Further, the transaction selected for audit appears on the Today Page of the research specialist 104 who is the transaction auditor 109 and is assigned the audit sales transaction 1003.

After the transaction auditor 109 receives the invoice and supporting documents, the transaction auditor 109 reviews the sales/transaction information 1004. If the sales/transaction information is correct, the transaction auditor 109 approves the entry. The sales entry is completed and saved in the high value asset server 101 under dealer history and under the history of the high value asset 1006. If the sales/transaction information is incorrect, the transaction auditor 109 sends the dealer 103 notes from the audit 1007. The transaction auditor 109 adds the failed audit to the dealer's 103 histories and to the high value asset's 101 history 1008. The high value asset server 101 alerts the dealer 103 to the failed audit by a system notification on the dealer 103 interface. If the entry is not complete or is incorrect, the high value asset server 101 prompts the dealer 103/buyer 111 to complete all fields and files 1009.

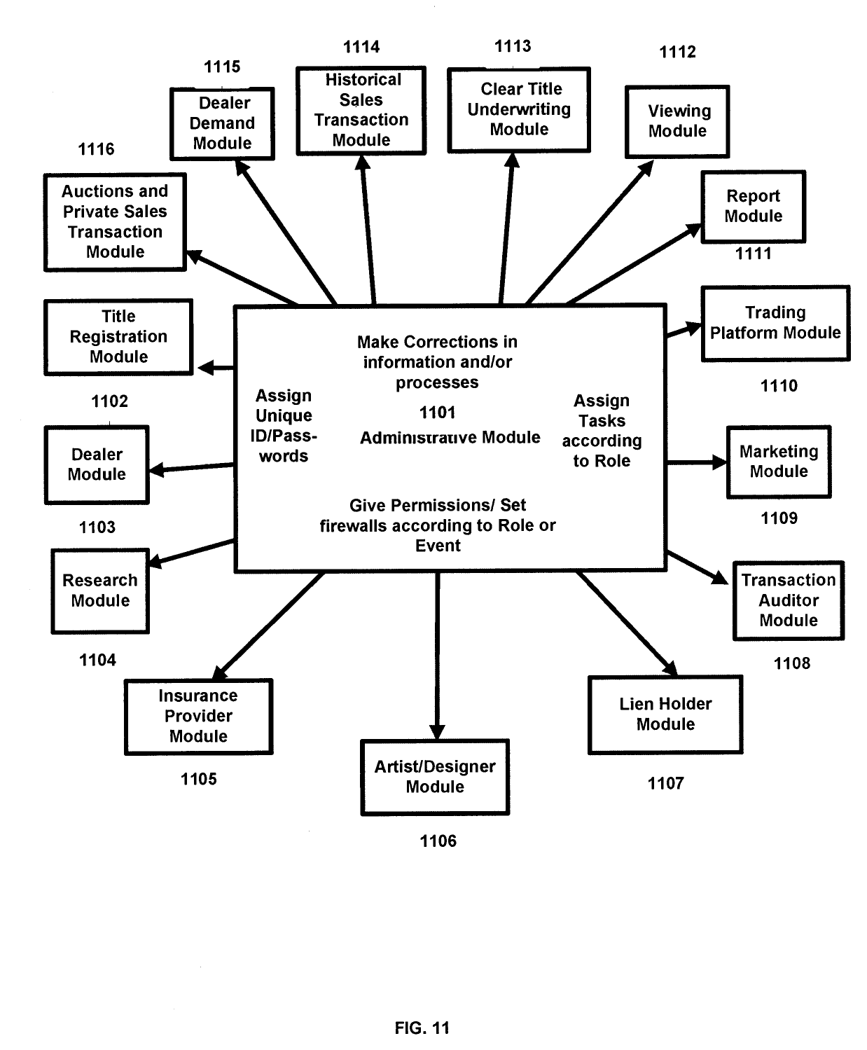

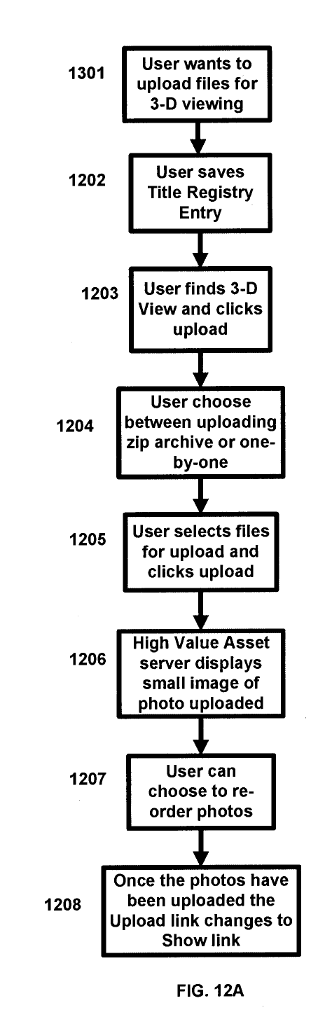

FIG. 11 illustrates a flow chart of the administrative module. A typical administrator's 106 interface displays information that allows the administrator 106 to provide oversight and assistance to each of the modules of the high value asset server 100 shown in FIG. 2. It also allows the administrator 106 to interact with each of the internal and external user roles. A typical administrator's 106 interface presents information and displays an event and option calendar. A typical administrator's 106 interface displays all the high value assets 101 under assessment that have been assigned but have not been approved, have been rejected or listed on the trading platform with a status not equal to complete. A typical administrator's 106 interface displays the high value assets 101 that have been approved after assessment and are awaiting upload to the trading platform, those requiring research director 104B approval, and those not approved which have a complete status. A typical administrator's 106 interface displays the high value assets 101 that have been removed from the trading platform, except for those removed as unsold and already approved by the research director. A typical administrator's 106 interface also displays the high value assets 101 that have been listed for sale on the trading platform. A typical administrator's 106 interface displays the high value assets 101 that have active offers from dealers 103 listed for sale on the trading platform. A typical administrator's 106 interface displays the high value assets 101 that are under option request which are not marked paid in full or canceled or have been listed for sale with an option on the trading platform. A typical administrator's 106 interface displays the list of non-approved sales by the transaction auditor.

The administrative module 1101 interacts with all of the modules. The administrative module 1101 functions give permissions and set firewalls according to the user role or an event that may change a user's permissions, firewalls or roles. The administrative module 1101 also functions to assign tasks according to user role or an event that may change a user's permissions, firewalls or role or unique ID and passwords according to a user's role. The administrative module 1101 also functions to make corrections in information for processes in the respective module. The administrator's 106 role is also the user that creates and assigns all other user rights to the system. The administrator 106 enters all of the detailed information on a user, including mailing address, telephone, e-mail address, etc. that goes into the system. This information in the system is the customer relationship management system that the administrator role oversees.

Internal users of the high value asset server 100 that have report permission on the high value asset server 100 can generate and view reports in the report module. The reports menu includes reports concerning: chats and messages; online users; login statistics; major markets; location; trading platform viewing statistics; site section viewing statistics; option request statistics; offer statistics; trading platform sales statistics; auction sale statistics; private sale statistics; dealer sale statistics; artist sale statistics; high value asset statistics; owner change statistics; recorded insurance company; insured value; insured value by postal code; liens; title registry account; title registry recording fee statistics; invoice; user password; and auction sales entry. In addition, there are work flow reports and quality control reports that apply to the auction sales entry process and the artist entry process that is used to monitor that work flow.

There are multiple reports that can be generated by the high value asset server 100 concerning chats and messages. The reports on message and chat statistics can be for the following reported categories: business developer 110 to research specialist 104; dealer 103 to business developer 110; dealer 103 to research specialist 104; and other. The message and chat statistic reports outline the number of messages or chats and their duration, and these reports can be exported to spreadsheet software. Message and chat log reports concern information about all messages and chats on the high value asset server 100 for a selected date range. Message and chat log reports can be generated for a report period (custom, day, week, month, quarter, year), by sender (organization and person) and recipient (organization and person). Further, message reports can be generated by subject of the message.

The online users report generates information concerning the users logged into the high value asset server 100 and the duration of their sessions. The online user report consists of columns that indicate the login time and time online per user. The login statistics report generates information concerning the number of user logins and total user session duration for selected date range. There is ability to arrange the login statistic report by user or organization for a report period and/or date. The login statistic report displays the total logins and total time online per user.

The major markets report generates information concerning the total number of users that have access to major markets. The location report generates information concerning the total number of users grouped by location. There is the ability to get information from the location report by country, region and city.

The trading platform viewing statistics report generates information concerning the total number of trading platform details page visits, total duration of visits and number of file downloads from trading platform by report period and date. The trading platform viewing statistics report columns are assessment number, artist, title, total views and duration. The site section viewing statistics report generates information concerning the total number and duration of page visits grouped by site sections for a report period or date. The site section viewing statistics report columns are site section, total views and total viewing duration.

The option request statistics report generates information concerning the total number and value of options requested on selected date range or report period. The reports contain display information about option type by report period or date. The type of options include all options, 12-month exclusivity option price, 6-month exclusivity option price, exhibition option price (per exhibition venue) and publication option price (12 months). The offer statistics report generates information concerning the total number and value of offers made by report period or date. The offer statistics report displays information by high value asset 101 category by date or report period. Users can get a more detailed offer statistic report by checking detailed report to sort by major markets and minor markets.

The trading platform sales statistics report generates information concerning the total number and value of trading platform sales in selected date range grouped by period or artist/designer. The trading platform sales statistics report can be displayed by report period, date, artist or category. The auction sales statistics report generates information concerning the total number and value of auction sales for selected date range grouped by period. The auction sales statistics report can be displayed by report period, date, artist or category. The private sales statistics report generates information concerning the total number and value of private sales for selected date range grouped by period. The private sales statistics report can be displayed by report period, date, artist or category. There is an ability to make a private sales statistics report for selected markets. The dealer sales statistics report generates information concerning the total number and value of dealer sales for selected date range grouped by dealer's name. The dealer sales statistics report can be displayed by report period, date, artist, category or transaction type (sales or purchases). There is an ability to make a dealer sales statistics report for selected markets. The art sales statistics report generates information concerning the total number and value of sales for a selected date range grouped by artist's name. The artist sales statistics report can be displayed by report period and/or date.

The high value asset statistic report generates information about the registration entries added to the high value asset server 100 for a selected date range group by period. There is an ability to make a high value asset statistics report by artist. The artist sales statistics report generates information about the total number and value of sales for selected date range grouped by artists. The ownership changes statistics generates information about the title entries in the high value asset server 100 that have changed owners in a selected date range, grouped by period.

The recorded insurance companies report generates information about the insurance companies added to high value asset server 100 at selected date range and grouped by period. The insured value report generates information about the value of insurance policies in the high value asset server 100 for a selected date range grouped by period. The insured value by postal code report generates information about the amount of high value assets 100 by the owner's postal code. The lien report generates information about the recorded liens for a selected date range grouped by period. There is the ability to make a lien report for selected organizations. A user can choose to display the organization, the liens added, the liens removed and the total insured value. There is the ability to make graphical reports for recorded insurance company reports, insured value reports and insured value by postal code and lien reports.

The title registry accounts report generates information about the title registry accounts added to high value asset server 100 at selected date range and grouped by period. The title registry recording fee statistics report generates information about the total amount of recording fees for a selected date range grouped by period. There is the ability to view recorded high value assets 101 in the registry recording fee statistics report. The invoice report generates information about the invoices in high value asset server 100 for a selected date range. There is the ability to select the type of invoice in the invoice report. The user password report generates information about the user passwords stored in the high value asset server 100. The user password report is sorted by user name and user ID. The title registry password report generates information concerning the registry passwords stored in the high value asset server 100. The title registry password report can be sorted by title registry number and title registry name.

The auction sales entry report generates information on the auction sales entries for a selected date or report period. The auction sales entry report can contain statistics on auction sales entries made for a certain artist grouped by the user who added the entry. The auction sales entry report can contain statistics on auction sales entries made for a certain artist grouped by the user who modified the entry. The auction sales entry report can contain statistics on auction sales entries by the user who added the entry. The auction sales entry report can contain statistics on auction sales entries by the user who modified the entry. The auction sales entry report can contain statistics on auction sales entries by date range.

The pages and lists in the high value asset server 100 include search and filtering tools. The searchable pages are as follows: artist list; jewelry designer; users; title registry; owners; assessment protocol; underwriting title; dealer data entry; auction data list; dealer demand; trading platform; dealer applicants; option sales; previous chat sessions; and messages. The user of the high value server 100 has an option to check the “View in New Window” checkbox, and the search button performs filtering by specified criteria, while the “Reset” button clears all filtering options selected.

The artist list page has an artist filter that allows search by artist's name—searching by first, last, middle or alternative names; nationality; life period; credentials; and major or minor markets. The jewelry designer's page has a filter that allows search by designer's name or major or minor markets. The user's page has a filter that allows search by first, last or middle names; organization; role; assigned permissions; and status (active/inactive).

The title registry page has a filter that allows search by high value asset category; title registry number; artist/designer; high value asset title; medium; condition; date of entry; owner name; fine art and/or title insurance provider; lien holder; listed in catalogue raisonné; stolen flag and assigned keywords. Paintings, photographs and sculptures can be searched by dimensions (framed and unframed for paintings and photography). Jewelry items can be also searched by period; jewelry type; size/length; stone characteristics: type, shape, weight, color, clarity; and certification reports flag.

The owner's page has a filter that allows search by first, last and middle names; organization; e-mail address; country/city; and owner type (individual, corporation or trust, etc.) The assessment protocol page has a filter that allows search by high value asset category; artist/designer; medium; condition; location; fair market retail value price range; assessment number; assessment status (not assigned, assigned, completed approved, etc.); major and minor markets; keywords; dimensions (framed/unframed for paintings and photography), and listed in catalogue raisonné flag. The jewelry category allows user to search database also by period; jewelry type; size/length; stone characteristics: type, shape, weight, color, clarity, and certification reports flag.

The underwriting title page has a filter that allows search by high value asset category; artist/designer; medium; condition; location; insured value range; underwriting title number; entry status (not assigned, assigned, completed approved, etc.); major and minor markets; keywords; dimensions (framed/unframed for paintings and photography); and listed in catalogue raisonné flag. The jewelry category allows user to search database also by period; jewelry type; size/length; stone characteristics: type, shape, weight, color, clarity; and certification reports flag.

The dealer data entry page has a filter that allows search by high value asset category; artist; artist credentials; medium; major and minor markets; condition; location of sale; period when entries were added into the database; dimensions (unframed/framed); and keyword. The jewelry category allows user to search database also by period; jewelry type; size/length; stone characteristics: type, shape, weight, color, clarity, and certification reports flag.

The auction data list has a filter that allows search by high value asset category; artist/designer; artist credentials; medium; major and minor markets; auction house; auction date range; lot number; size of high value asset; and keyword. The jewelry category allows user to search database also by period; jewelry type; size/length; stone characteristics: type, shape, weight, color, clarity; and certification reports flag.

The dealer demand page has a filter that allows search by high value asset category; artist/designer; title registry number; similar high value asset name; medium; condition; entry date range; and dealer. The trading platform page has a filter that allows search by artist/designer; medium; condition; location; fair market retail value price range; retail value price range; minor markets; keywords; and “Listed in Catalogue Raisonné” flag.

The dealer applicant page has a filter that allows search by first, last and middle names of a dealer applicant; organization; and role and status (active/inactive).

The option sales page has a filter that allows search by assessment number; option type; dealer; status (new, approved invoiced, etc.); and entry date range.

The previous chat sessions page has a filter that allows search by person, title registry number in chat subject and by chat session number. The messages page has a filter that allows search by sender/recipient, status (unread, read replied, etc.) and date range.

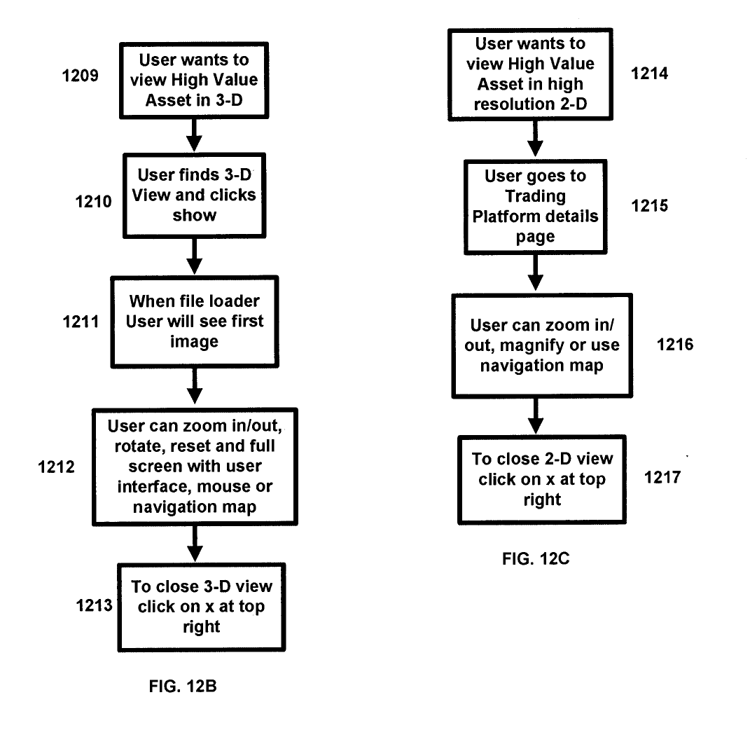

FIG. 12 illustrates a flow chart of the viewing module for uploading pictures (A) and viewing in 3-D (B) and high resolution 2-D (C). The high value asset server 100 allows 360-degree viewing. This feature of the high value asset server 100 requires downloading software called “Silver Light” framework from the MICROSOFT® Web site. If the software is not present on the user's computer, the user will receive a message that the software is not installed, and a link for downloading the software will be provided. For high value assets 100 that are in the category of sculptures and jewelry, the high values asset server 100 offers the ability to view these categories of high value assets 101 at different views. The 360-degree viewing feature of the high value asset server requires a series of the pictures of the object at various angles to be taken and subsequently uploaded to the high value asset server 100. The photographs can be uploaded on the title registry entry page or on the assessment protocol page.

In order to use the 360-degree viewing feature, digital imagery and/or photographic imagery files may be uploaded 1201. The files can be added for an existing high value asset 101 entry. Prior to uploading photographs for a title registry entry, the title registry entry should be saved 1202. The “3D View” option can be found in the file list under either the registration tab for title registry or file upload tab for assessment protocol 1203. After the “3D View” option is found, the user clicks “Upload” 1203. The user has the option to upload all files in the zip archive or upload one-by-one 1204. If the user selects “one-by-one,” the user has an ability to rearrange uploaded images so that they are displayed in a particular sequence. By default, the system will assume that images are to be sorted by file name. To add files for upload, the user clicks “Select Files” 1205. To remove the file from the upload list, the user clicks the red “X” icon. To remove all files, the user clicks the “Clear” button. To start uploading files, the user clicks the “Upload” button 1205.

Once a file is uploaded, the user will see its reduced image 1206. If the user has chosen to reorder images after upload, the user will be able to change their order by using arrow icons or by dragging files inside the box. After the user has completed the ordering of the image, the user clicks “Perform Ordering” 1207. The system will process all uploaded files and store them in the high value asset server 100. Depending on the size of the files, the uploading process can take considerable time. While images are being processed, if the user clicks “Upload” again, the user is sent a message that the high value asset server 100 is preparing a 3D model, and the message will show an approximate status of completion. Once the uploading process is complete, the “Upload” link will change to a “Show” link, which means that all uploaded files have been successfully loaded and processed 1208.

The high value asset server 100 allows 360-degree viewing 1209. First, the user must find the “3D View” option 1210. The “3D View” option can be found in the file list under either the registration tab for title registry or the file upload tab for assessment protocol. After the “3D View” option is found, the user clicks “Show” 1210. After the viewer window loads, the user can view the first photograph from the series 1211. The “3D View” user interface consists of: a main viewing window; a reduced image in the bottom left corner for quick navigation; “rotate” buttons (left/right arrows) to switch between pictures; zoom in/out buttons (+/−); reset viewed location button (house); switch into/from full screen mode; and help 1212.

The user can also use the mouse for faster operation to zoom in—right click; to zoom out—SHIFT+right click or use scroll wheel to zoom in/out; hold left mouse button and move mouse left/right to rotate viewed object; and hold right mouse button and move mouse to view area of the image 1212. The user can also point at the navigation map (small image at the bottom left corner) and use the mouse scroll wheel to rotate object and hold right mouse button and move cursor to move around the image. While in full screen viewing mode, press Esc to return into window mode or use the button from control panel 1212. To close the 3D viewer, the user clicks the “X” icon at the top right corner 1213. The high value asset server 100 allows any image to be uploaded in high resolution 2-D.

The high value asset server 100 also allows viewing of the high resolution 2-D images 1214. A user can view the front view photographic image in detail online, and the user has the ability to zoom in/out for better details. The full screen feature and the zoom feature are available on the trading platform details page 1215. To use the full screen feature and/or the zoom feature, click the “Viewer UI” link under the main photography preview. The “Viewer UI” link contains a zoom in/out slider with zoom percentage indication, a magnifier tool (enlarges viewed area a bit) and a navigation map 1216. To change the zoom level, the user can simply move the zooming slider left or right. If the image does not fit into the screen, the user can move around by holding the left mouse button and moving the cursor or by using the navigation map at the bottom of the page 1216. To close the 2-D viewer, the user clicks the “X” icon at the top-right corner 1217.

Each of the features and teachings disclosed herein can be utilized separately or in conjunction with other features and teachings to provide a method for reducing the order of system models exploiting sparsity. Representative examples utilizing many of these additional features and teachings, both separately and in combination, are described in further detail with reference to the attached figures. This detailed description is merely intended to teach a person of skill in the art further details for practicing preferred aspects of the present teachings and is not intended to limit the scope of the claims. Therefore, combinations of features disclosed above in the detailed description may not be necessary to practice the teachings in the broadest sense, and are instead taught merely to describe particularly representative examples of the present teachings.

In the description above, for purposes of explanation only, specific nomenclature is set forth to provide a thorough understanding of the present disclosure. However, it will be apparent to one skilled in the art that these specific details are not required to practice the teachings of the present disclosure.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk, including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms presented herein are not inherently related to any particular computer or other apparatus. Various general purpose systems, computer servers, or personal computers may be used with programs in accordance with the teachings herein, or it may prove convenient to construct a more specialized apparatus to perform the required method steps. The required structure for a variety of these systems will appear from the description below. It will be appreciated that a variety of programming languages may be used to implement the teachings of the disclosure as described herein.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples.

A method and system for high value asset registration, authentication, clear title underwriting, valuation, work flow management, trading and lien recording have been disclosed. Although various embodiments have been described with respect to specific examples and subsystems, it will be apparent to those of ordinary skill in the art that the concepts disclosed herein are not limited to these specific examples or subsystems but extends to other embodiments as well. Included within the scope of these concepts are all of these other embodiments as specified in the claims that follow.

What is claimed is:

1. A computer implemented method, comprising:
receiving from one or more client computers, a high value asset registration request; and
receiving high value asset data, wherein the high value asset data includes one or more of high value asset description data, high value asset image data, clear title underwriting data, trading platform data, lien data, work flow management data, artist and designer data, assessment protocol and valuation data, insurance provider data, administrative data, business development data, historical sales transaction data, auction and private sales data, and dealer demand data.
